(19) United States
(12) Patent Application Publication
(10) Pub. No.: US 2024/0058874 A1
(43) Pub. Date: Feb. 22, 2024

(54) POCKET HOLE JIG

(71) Applicant: Techtronic Cordless GP, Anderson, SC (US)

(72) Inventors: Trevor Fauss, Greenville, SC (US); Jeffrey Groves, Greenville, SC (US); Thomas Evatt, Six Mile, SC (US); Clinton C. Thackery, Clemson, SC (US)

(21) Appl. No.: 18/501,671

(22) Filed: Nov. 3, 2023

Related U.S. Application Data
(63) Continuation-in-part of application No. 18/338,686, filed on Jun. 21, 2023.
(60) Provisional application No. 63/354,831, filed on Jun. 23, 2022.
(60) Provisional application No. 63/429,203, filed on Dec. 1, 2022.

(51) Int. Cl. B23B 47/28

(52) U.S. Cl. CPC B23B 47/287

(57) ABSTRACT

A pocket hole jig includes: a body; an actuator moveably coupled to the body; a clamp head moveable between an open state and a closed state, wherein the clamp head selectively secures a workpiece in a clamping region of the pocket hole jig in the closed state; a spring biasing the clamp head to the open state; a drill guide defining a guide axis for a drill bit; and a linkage extending between the actuator and each of the clamp head and the drill guide to move the clamp head between the open and closed states in response to movement of the actuator.

### CROSS-REFERENCE TO RELATED APPLICATIONS

The present application is a continuation in part of U.S. patent application Ser. No. 18/338,686, filed on Jun. 21, 2023 which claims priority to U.S. Patent Application Ser. No. 63/354,831 filed on Jun. 23, 2022 and U.S. Patent Application Ser. No. 63/429,203, filed on Dec. 1, 2022, the disclosures of which are incorporated by reference herein in their entireties.

### FIELD

The present disclosure relates generally to hand tools for cabinet and furniture making, and more particularly to pocket hole jigs.

### BACKGROUND

When constructing cabinets and furniture, it is often necessary to butt join or otherwise couple two or more objects together. Pocket holes are often utilized to conceal the fasteners joining the objects together. The pocket holes generally plunge from a side surface of the object through an end face thereof. The object can then be butted against another object and a fastener can extend through the pocket hole into the other object to secure the objects together.

### BRIEF DESCRIPTION

Aspects and advantages of the invention in accordance with the present disclosure will be set forth in part in the following description, or may be obvious from the description, or may be learned through practice of the technology.

In accordance with one embodiment, a pocket hole jig is provided. The pocket hole jig includes a body; an actuator moveably coupled to the body; a clamp head moveable between an open state and a closed state, wherein the clamp head selectively secures a workpiece in a clamping region of the pocket hole jig in the closed state; a spring biasing the clamp head to the open state; a drill guide defining a guide axis for a drill bit; and a linkage extending between the actuator and each of the clamp head and the drill guide to move the clamp head between the open and closed states in response to movement of the actuator.

In accordance with another embodiment, a pocket hole jig is provided. The pocket hole jig includes a body; an actuator moveably coupled to the body; a clamp head moveable between an open state and a closed state, wherein the clamp head selectively secures a workpiece in a clamping region of the pocket hole jig in the closed state; a spring biasing the clamp head to the open state; a drill guide defining a guide axis for a drill bit; and a linkage extending between the actuator and each of the clamp head and the drill guide to move the clamp head between the open and closed states in response to movement of the actuator.

In accordance with another embodiment, a pocket hole jig is provided. The pocket hole jig includes a housing including a plurality of first lock structures; an axle coupled to the housing; a drill bit guide coupled to the axle, the drill bit guide defining a guide axis; and a spring-loaded bushing coupled to the drill bit guide, the spring-loaded bushing including at least one second lock structure, wherein the spring-loaded bushing is translatable along the drill bit guide between an engaged position where the at least one second lock structure is engaged with one of the plurality of first lock structures to maintain the guide axis at a fixed angle relative to a workpiece and a disengaged position where the spring-loaded bushing is translatable along the drill bit guide and the drill bit guide is rotatable about the axle.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1 is a perspective view of a pocket hole jig in accordance with one or more embodiments of the present disclosure;

FIG. 2 is a first side view of the pocket hole jig of FIG. 1 in accordance with one or more embodiments of the present disclosure;

FIG. 3 is another first side view of the pocket hole jig of FIG. 1 in accordance with one or more embodiments of the present disclosure;

FIG. 4 is a top view of the pocket hole jig of FIG. 1 in accordance with one or more embodiments of the present disclosure;

FIG. 5 is a cross-sectional view of the pocket hole jig of FIG. 1 in accordance with one or more embodiments of the present disclosure;

FIG. 6 is a perspective view of the pocket hole jig of FIG. 1 in accordance with one or more embodiments of the present disclosure;

FIG. 7 is a perspective view of another pocket hole jig in accordance with one or more embodiments of the present disclosure;

FIG. 8A is a perspective view of another pocket hole jig in accordance with one or more embodiments of the present disclosure;

FIG. 8B is a perspective view of a body of the pocket hole jig of FIG. 8A in accordance with one or more embodiments of the present disclosure;

FIG. 8C is a perspective view of a spring-loaded bushing of the pocket hole jig of FIG. 8A in accordance with one or more embodiments of the present disclosure;

FIG. 9 is a perspective view of another pocket hole jig in accordance with one or more embodiments of the present disclosure;

FIG. 10 is a perspective view of the pocket hole jig of FIG. 9 as seen with a portion of a body of the pocket hole jig removed in accordance with one or more embodiments of the present disclosure;

FIG. 11 is a perspective view of the pocket hole jig of FIG. 9 as seen with a portion of a body of the pocket hole jig removed in accordance with one or more embodiments of the present disclosure;

FIG. 12 is a side view of the pocket hole jig of FIG. 9 as seen with an actuator of the pocket hole jig in a closed position in accordance with one or more embodiments of the present disclosure;

FIG. 13 is a side view of the pocket hole jig of FIG. 9 as seen when the actuator is initially moved from the closed position in accordance with one or more embodiments of the present disclosure;

FIG. 14 is a side view of the pocket hole jig of FIG. 9 as seen when the actuator is moved from the closed position in accordance with one or more embodiments of the present disclosure;

FIG. 15 is a side view of the pocket hole jig of FIG. 9 as seen when the actuator is in an open position in accordance with one or more embodiments of the present disclosure;

FIG. 16A is a side view of an actuator according to one or more embodiments of the present disclosure;

FIG. 16B is a side cross-sectional view of an actuator according to one or more embodiments of the present disclosure;

FIG. 16C is a perspective view of an actuator according to one or more embodiments of the present disclosure;

FIG. 16D is a perspective cross-sectional view of an actuator according to one or more embodiments of the present disclosure;

FIG. 17A is a perspective view of a pocket hole jig in accordance with one or more embodiments of the present disclosure;

FIG. 17B is a perspective view of a pocket hole jig in accordance with one or more embodiments of the present disclosure;

FIG. 18 is a perspective view of a carriage and dust extraction element of the pocket hole jig in accordance with one or more embodiments of the present disclosure;

FIG. 19 is a perspective view of a carriage and dust extraction element of the pocket hole jig in accordance with one or more embodiments of the present disclosure;

FIG. 20 is a perspective view of a drill guiding element in accordance with one or more embodiments of the present disclosure;

FIG. 21 is a perspective view of a drill guiding element in accordance with one or more embodiments of the present disclosure;

FIG. 22 is a cross-sectional view of the pocket hole jig of FIG. 17 in accordance with one or more embodiments of the present disclosure;

FIG. 23 is an enlarged cross-sectional view of a portion of the pocket hole jig in accordance with one or more embodiments of the present disclosure;

FIG. 24 is a side view of a pocket hole jig as seen with a clamping region in an open state in accordance with one or more embodiments of the present disclosure;

FIG. 25 is a side view of the pocket hole jig as seen with the clamping region in a closed state in accordance with one or more embodiments of the present disclosure;

FIG. 26 is a side view of the pocket hole jig as seen with the clamping region in an open state with a portion of a body of the pocket hole jig removed in accordance with one or more embodiments of the present disclosure;

FIG. 27 is a side view of the pocket hole jig as seen with the clamping region in a closed state with a portion of the body of the pocket hole jig removed in accordance with one or more embodiments of the present disclosure;

FIG. 28 is a rear perspective view of a portion of the pocket hole jig including an actuator and a locking structure in accordance with one or more embodiments of the present disclosure;

FIG. 29 is a rear perspective view of the pocket hole jig in accordance with one or more embodiments of the present disclosure;

FIG. 30 is a side view of a portion of the pocket hole jig in accordance with one or more embodiments of the present disclosure;

FIG. 31 is a side view of a portion of the pocket hole jig in accordance with one or more embodiments of the present disclosure;

FIG. 32 is a front view of a vacuum attachment port for use with the pocket hole jig in accordance with one or more embodiments of the present disclosure;

FIG. 33 is a rear perspective view of the vacuum attachment port in accordance with one or more embodiments of the present disclosure;

FIG. 34 is a side perspective view of the vacuum attachment port in accordance with one or more embodiments of the present disclosure;

FIG. 35 is a bottom view of the pocket hole jig in accordance with one or more embodiments of the present disclosure;

FIG. 36 is a perspective view of a pocket hole jig in accordance with one or more embodiments of the present disclosure;

FIG. 37 is a cross-sectional view of the pocket hole jig as seen along Line A-A in FIG. 36 in accordance with one or more embodiments of the present disclosure;

FIG. 38 is a perspective view of components of the pocket hole jig with a housing of the pocket hole jig removed in accordance with one or more embodiments of the present disclosure;

FIG. 39 is a side view of a bushing of the pocket hole jig in accordance with one or more embodiments of the present disclosure;

FIG. 40 is a side view of a portion of the pocket hole jig in accordance with one or more embodiments of the present disclosure; and

FIG. 41 is a rear perspective view of a pocket hole jig in accordance with one or more embodiments of the present disclosure.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive- or and not to an exclusive- or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, pocket hole jigs described herein allow users to easily align and/or clamp objects, e.g., wood, and drill the objects at specified alignments with respect to the objects. Pocket hole jigs may generally include a body and a pivotable drill guide.

One or more embodiments may include a translating nose fence. According to one or more embodiments, the drill guide may be rotatable about an axle to set an angle and depth of the drill guide. One or more embodiments may further include locking notches into which locking tabs are inserted to set the angle and depth of the drill guide.

One or more embodiments may further include a moveable clamp head and an actuator engageable by the user such that, as the user moves the actuator to a closed position, the clamp head tightens against an object positioned in a clamping region of the pocket hole jig. Movement of the actuator additionally locks the clamp head in a tightened state against the object. Movement of the actuator additionally rotates the drill guide to a suitable angle whereby a drill guided by the drill guide is ideally (or at least better) positioned for that dimensioned object. That is, the drill guide can be self-aligning. Without wishing to be bound by any particular principle, use of pocket hole jigs as described herein can eliminate the requirement of using two hands to use the pocket hole jig to tighten and lock objects while also self-aligning the drill guide to a suitable angular position based on the dimension of the object disposed in the clamping region.

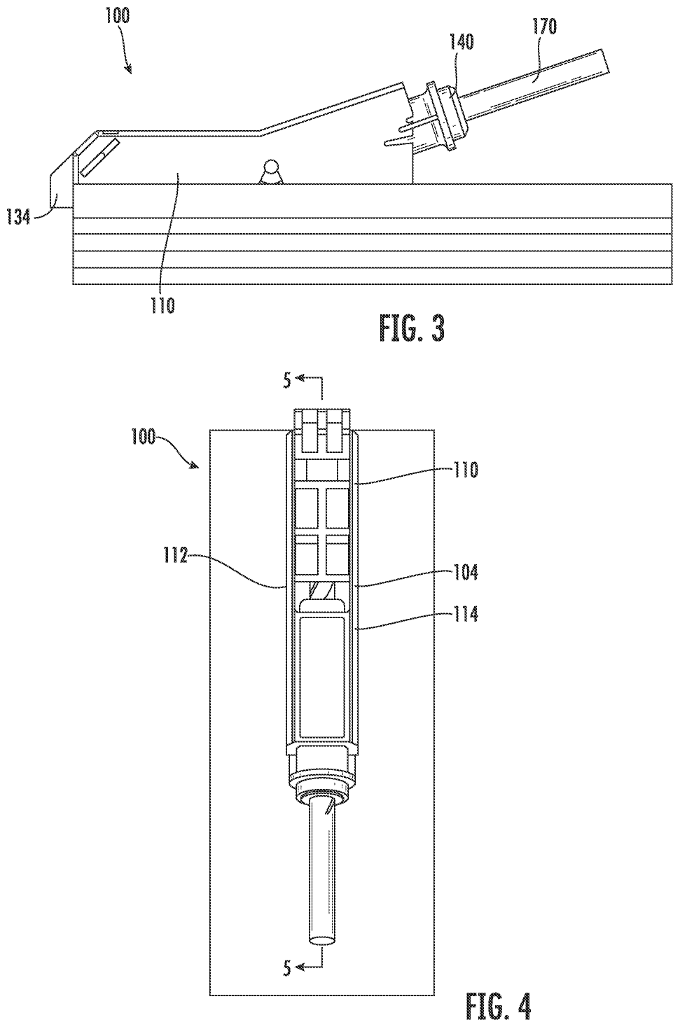

Referring now to the drawings, FIGS. 1 to 6 illustrate a pocket hole jig 100 in accordance with an exemplary embodiment disposed on a workpiece 102, e.g., a piece of wood. The pocket hole jig 100 can generally include a housing 110 having a first sidewall 112 and a second sidewall 114 spaced apart from the first sidewall 112. A top 116 can connect the first sidewall 112 to the second sidewall 114. The top 116 can include an upper portion 118 and a lower portion 120. The lower portion 120 of the top 116 can include a plurality of strength structures 122 which provide strength and support to the housing 110.

The housing 110 of the pocket hole jig 100 includes a proximal end 130 and a distal end 132. A translating nose fence 134 can disposed at the distal end 132 of the housing 110 and can translate linearly along an axis 136 that forms an angle A with respect to the surface of the workpiece 102. In an embodiment, the angle A can be offset from parallel and perpendicular with respect to a surface of the workpiece 102. For example, the relative angle A can be between 0° and 90°, as measured with respect to the workpiece 102, such as between 10° and 80°, such as between 20° and 70°. The translating nose fence 134 can translate to a stored position to allow the pocket hole jig 100 to be used inside of material that is being joined. For example, the pocket hole jig 100 may be used inside already-formed drawers, cabinets, or the like to form pocket holes. With the translating nose fence 134 in the stored position, the pocket hole jig 100 can be positioned at the existing joint. With the translating nose fence 134 deployed, the translating nose fence 134 can form a stop feature which aligns the pocket hole jig 100 relative to an end surface of the workpiece 102 such as shown in FIG. 1.

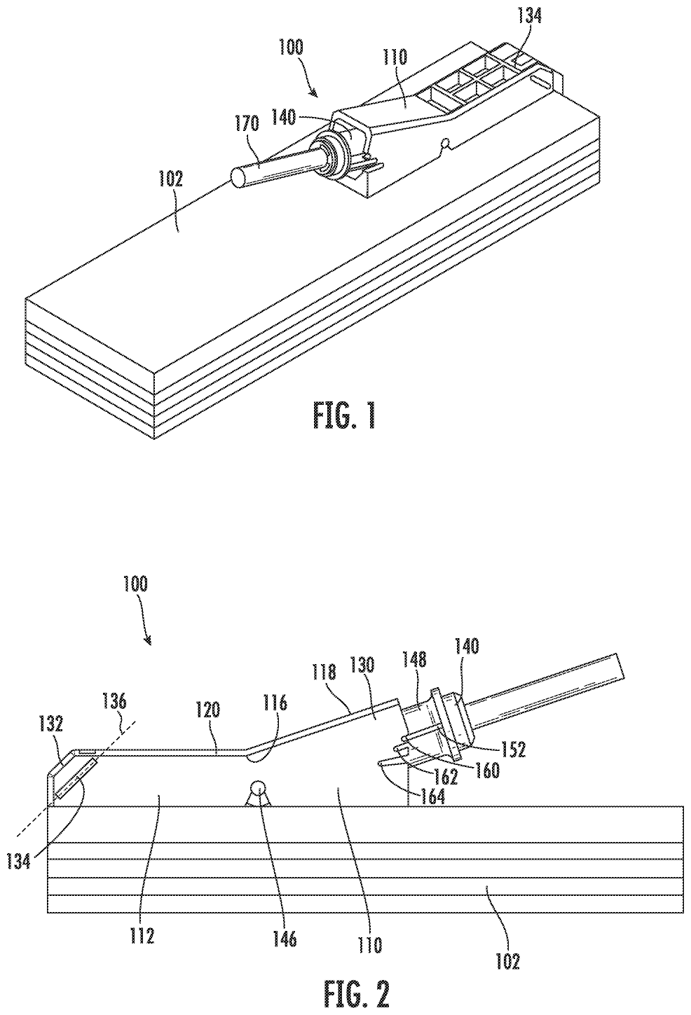

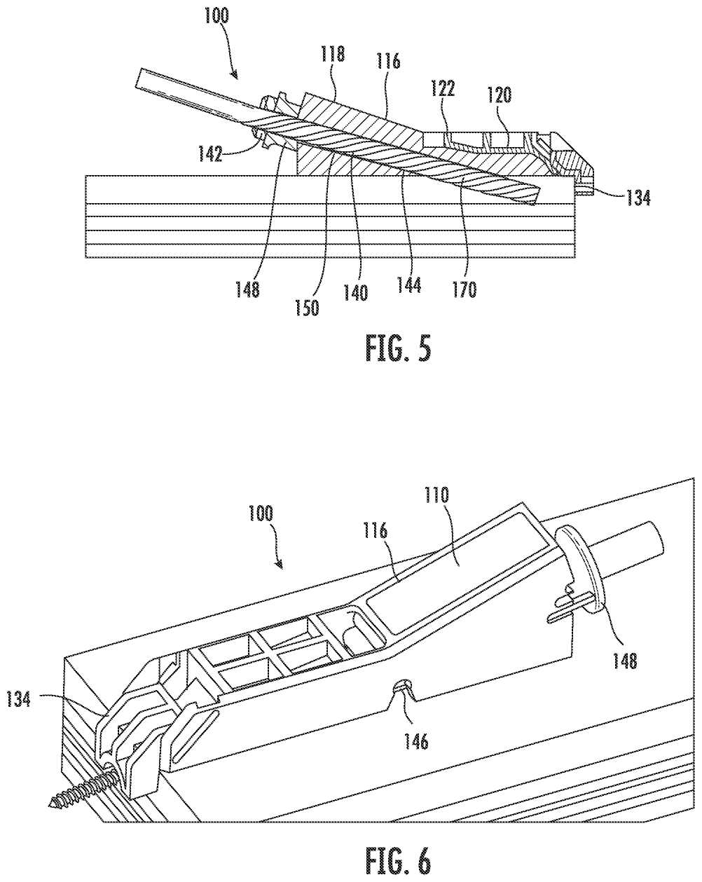

The pocket hole jig 100 further includes a drill bit guide 140 that includes a proximal end 142 and a distal end 144 (FIG. 5). As shown in FIGS. 2 and 3, the drill bit guide 140 includes an axle 146 around which the drill bit guide 140 selectively rotates. A spring-loaded bushing 148 is disposed around the proximal end 142 of the drill bit guide 140 and extends at least partially along the length of the drill bit guide 140. A spring 150 is disposed around the spring-loaded bushing 148 and is installed in tension in order to bias the spring-loaded bushing inward around the drill bit guide 140. The drill bit guide 140 includes a pair of locking tabs 152 diametrically opposed on the proximal end 142 of the drill bit guide 140.

Referring to FIG. 2, the sidewalls 112 and 114 can be formed with a plurality of locking notches, e.g., a first locking notch 160, a second locking notch 162, and a third locking notch 164. During use, the user can change a material thickness setting by pulling out the drill bit guide 140, e.g., using the spring-loaded bushing 148, and rotating the drill bit guide 140 about the axle 146 and within the sidewalls 112, 114, to align the locking tabs 152 with one of the locking notches 160, 162 or 164 and then releasing the spring-loaded bushing 148 to allow the locking tabs 152 to slide into the selected locking notch 160, 162 or 164. The drill depth and angle can be adjusted by moving the drill bit guide 140 as described. Further, the depth and the angle of the pocket hole drilled using the adjustable pocket hole jig 100 can be determined by the material thickness setting. Adjusting a stop collar on a drill bit 170 within the drill bit guide 140 is not necessary.

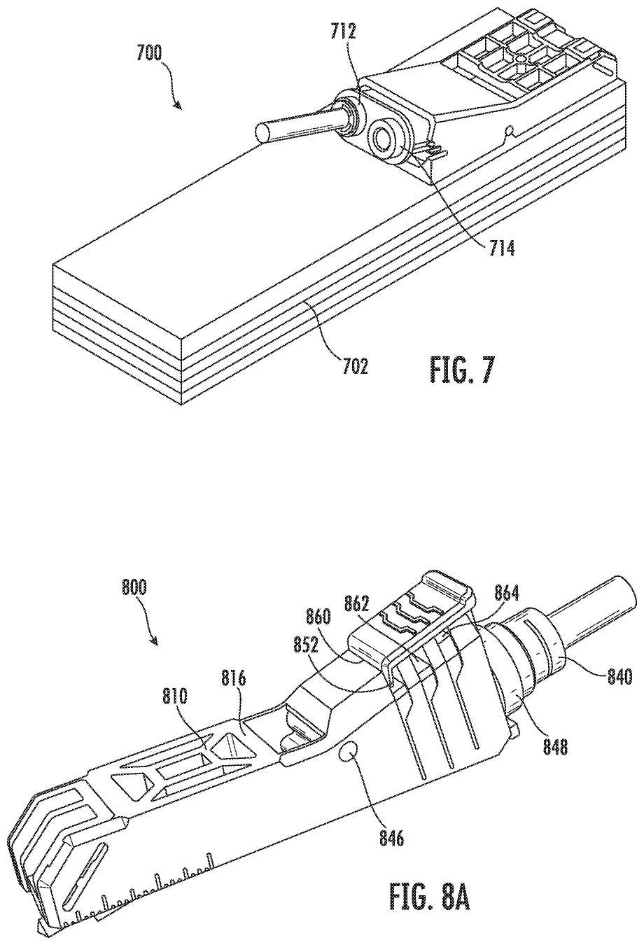

FIG. 7 illustrates another embodiment of a pocket hole jig 700 disposed on a workpiece 702, e.g., a piece of wood. The pocket hole jig 700 depicted in FIG. 7 can have any one or more features as described with respect to the pocket hole jig 100 described in conjunction with FIGS. 1 to 6. However, the pocket hole jig 700 depicted in FIG. 7 includes a first drill bit guide 712 and a second drill bit guide 714 that are disposed side-by-side and rotate in unison in a manner similar to the drill bit guide 140 of the pocket hole jig 100 shown in FIGS. 1 to 6. It should be understood that the pocket hole jigs described herein can be single hole pocket jigs or multi-hole pocket jigs including, e.g., two or more guides for drilling pocket holes.

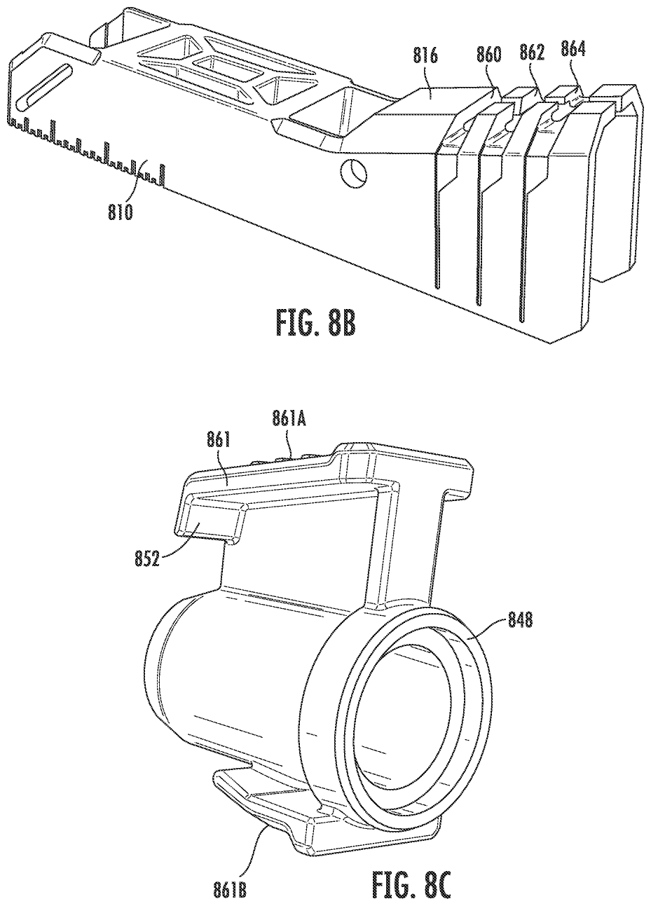

FIGS. 8A to 8C illustrate another embodiment of a pocket hole jig 800. The pocket hole jig 800 depicted in FIGS. 8A to 8C can have any one or more features as described with respect to the pocket hole jigs 100 and 700 described in conjunction with FIGS. 1 to 7. However, unlike the pocket hole jigs 100 and 700, the pocket hole jig 800 in FIGS. 8A to 8C includes a plurality of locking notches, e.g., a first locking notch 860, a second locking notch 862, and a third locking notch 864, disposed on a top 816 of a housing 810 of the pocket hole jig 800. During use, the user can change a material thickness setting by pulling out a spring-loaded bushing 848 and rotating a drill bit guide 840 about an axle 846, to align a locking tab 852 of the spring-loaded bushing 848 with one of the locking notches 860, 862 or 864 and then releasing the spring-loaded bushing 848 to allow the locking tabs 852 to slide into the selected locking notch 860, 862 or 864.

In an embodiment, the spring-loaded bushing 848 can include one or more user interfaces 861 which allow the operator to easily grasp and maneuver the spring-loaded bushing 848 between the locking notches 860, 862 and 864. In the depicted embodiment, the user interfaces 861 include an upper user interface 861A and a lower user interface 861B. The upper user interface 861A can be disposed above the top 816 of the body 810 while the lower user interface 861B can extend through a lower opening 863 in the body 810. The drill bit guide 840 (FIG. 8A) can pass between the upper and lower user interfaces 861A and 861B.

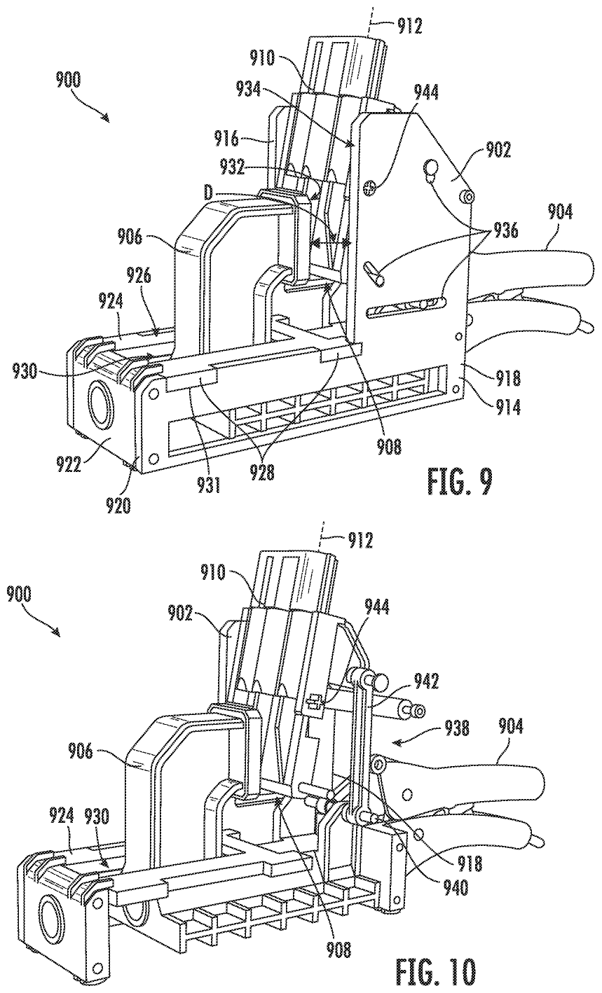

FIGS. 9 to 15 illustrate another embodiment of a pocket hole jig 900. The pocket hole jig 900 illustrated in FIGS. 9 to 15 is an automatic pocket hole jig. As used herein, the term “automatic pocket hole jig” refers to a tool which automatically clamps to an object which is to receive one or more pocket holes while also self-aligning an axis for drilling the pocket hole(s), where self-alignment can be referenced based on the size of the object being clamped. The automatic pocket hole jig may allow an operator to clamp and lock on to an object using a single hand to support the pocket hole jig 900. That is, the pocket hole jig 900 does not require the use two hands to operate, thus allowing the operator to grasp the object in their unused, other hand. Additionally, the pocket hole jig 900 can be locked in the clamped position, i.e., with an object clamped by the pocket hole jig 900, using the same actuating mechanism as used to clamp the object. Moreover, the pocket hole jig 900 may be brought to already-formed furniture and cabinets and used in-situ rather than requiring movement of the furniture to a fixed working area or disassembly of the furniture altogether.

Referring initially to FIGS. 9 to 11, the pocket hole jig 900 can generally include a body 902, an actuator 904 operatively coupled to the body 902, a clamp head 906 moveable relative to the body to selectively secure an object (not illustrated) in a clamping region 908 of the pocket hole jig 900, and a drill guide 910 defining a guide axis 912 for a drill bit (not illustrated) which can be guided by the drill guide 910 into the object. The drill guide 910 can define a single pocket hole jig defining one guide axis 912 or a multi-pocket hole jig having a plurality of guide axis 912. In certain instances, the guide axis 912 can be formed in a portion of the drill guide 910 which is adjustable, e.g., reversible. In such a manner, the operator can adjust a spacing between the guide axis 912 and the body 902 or between adjacent guide axis 912.

In an embodiment, the body 902 can include a single-piece construction including, e.g., a single-piece sidewall. In another embodiment, the body 902 can include a multi-piece construction. For example, referring to FIG. 9, the body 902 can include a first portion 914 and a second portion 916. In some instances, the first and second portions 914 and 916 can share any one or more of shape, size, or layout. The first and second portions 914 and 916 can be spaced apart from one another to define an area for the clamp head 906 and the drill guide 910.

The body 902 can define a proximal end 918 and a distal end 920. An end block 922 can be disposed at the distal end 920. The end block 922 can extend between the first and second portions 914 and 916 of the body 902 and couple the first and second portions 914 and 916 together. In an embodiment, the first and second portions 914 and 916 can be further coupled together through a top 924. By way of non-limiting example, the top 924 can include a generally planar exposed surface 926 and a plurality of outwardly extending tabs 928. The tabs 928 can seat within corresponding grooves 931 in the first and second portions 914 and 916 of the body 902. The top 924 can include an opening 930 through which the clamp head 906 can extend. While the top 924 is depicted as an upper surface of the pocket hole jig 900, in accordance with other, non-illustrated embodiments, the top 924 through which the clamp head 906 extends through can be disposed at another surface of the pocket hole jig 900 (e.g., at a side surface) or face another direction.

The clamping region 908 may be at least partially defined by the surface 926 and a clamp face 932 of the clamp head 906. As the clamp head 906 moves within the opening 930, i.e., translates between the proximal end 918 and distal end 920 of the body, a distance D between the clamp face 932 and a support surface 934 against which the object is clamped changes. When the pocket hole jig 900 is in the open position with the clamp head 906 nearest the distal end 920, the distance D is at its largest dimension. By way of non-limiting example, distance D at its largest size may be at least 1 inch, such as at least 2 inches, such as at least 3 inches, such as at least 4 inches, such as at least 5 inches. When the pocket hole jig 900 is in the closed position without any objects in the clamping region 908, the distance D is smallest and may be less than 1 inch, such as less than 0.5 inches, such as less than 0.25 inches, or even 0 inches. With an object in the clamping region 908 and the actuator 904 closed, the distance D is generally equal to the thickness of the object in a direction parallel with the distance D.

As shown in FIG. 9, the body 902 includes one or more delimiting features, e.g., a plurality of slots 936, which guide movement of an adjustment mechanism 938 (FIGS. 10 and 11). Guided by the delimiting feature(s), the adjustment mechanism 938 moves the clamp head 906 as the actuator 904 is moved between an open position and a closed position. The closed position is shown in FIGS. 9 to 11 and described below in greater detail.

The adjustment mechanism 938 can generally include a first connector 940 linking the actuator 904 and the clamp head 906 together and a second connector 942 linking the actuator 904 and the drill guide 910 together. In certain instances, the second connector 942 can link the actuator 904 and the drill guide 910 together through the first connector 940.

As illustrated in FIG. 10, the first connector 940 can include a generally T-shaped body with arms extending through openings in the clamp head 906. As depicted, the clamp head 906 can extend through the opening 930 in the top 924 and towards the actuator 904. The first connector 940 can extend through the clamp head 906 and interface with the second connector 942 which extends to the drill guide 910. As the actuator 904 is moved from the open position to the closed position, the first actuator 940 can translate the clamp head 906 toward the proximal end 918 of the body 902. The second connector 942, as a result of being linked with the first actuator 940, can pivot the drill guide 910, e.g., simultaneously, about a rotational axis 944. Thus, movement of the actuator 904 from the open position to the closed position tightens the clamp head 906 against the object in the clamping region 908. As described in greater detail below, movement of the actuator 904 to the closed position can also lock the clamp head 906 in a tightened state against the object. That is, the actuator 904 can both tighten the clamp head 906 and lock the object in the clamping region 908. As further described in greater detail below, movement of the actuator 904 to the closed position can also pivot the drill guide 910 about the rotational axis 944.

In the embodiment depicted in FIG. 10, the first connector 940 independently connects with each of the clamp head 906 and the second connector 942. That is, both the clamp head 906 and the second connector 942 directly interface with the first connector 940. In other embodiments, the first connector 940 can indirectly interface with at least one of the clamp head 906 or the second connector 942, e.g., through the other of the clamp head 906 or the second connector 942. It should be understood that the embodiments illustrated in FIGS. 9 to 15 are exemplary and not intended to limit the scope of the disclosure.

The pocket hole jig 900 can further include a support arm 946. In an embodiment, the support arm 946 is coupled to the body 902. For example, the support arm 946 can be a discrete component statically coupled to the body 902. In another embodiment, the support arm 946 can be integral with the body 902. For example, the support arm 946 can extend in a direction generally parallel with a best fit line of the actuator 904 as seen in the closed position. The combination of the actuator 904 and the support arm 946 can form a squeezable interface for moving the actuator 904 to the closed position. An operator can wrap their hand around the actuator 904 and the support arm 946 to generate leverage to squeeze the actuator 904 to the closed position. By applying pressure, the actuator 904 pivots to the closed position. Conversely, the actuator 904 pivots in a reverse direction when moving to the open position. In certain instances, reverse movement may be spring assisted using, e.g., a spring-biased interface 948 described in greater detail below.

While the clamping region 908 may receive objects of differing size in a direction parallel with the distance D (FIG. 9), in accordance with an embodiment the actuator 904 may always return to a substantially same closed position as measured relative to the support arm 946. That is, in the closed position, the actuator 904 may be in substantially the same position relative to other structure of the pocket hole jig 900, e.g., the support arm 946 or the body 902, regardless of the size of the object in the clamping region 908. In one or more embodiments, fully closing the actuator 904 to the closed position with differing sized objects contained in the clamping region 908 can be facilitated by the spring-biased interface 948 (FIG. 11).

The spring-biased interface 948 can couple the actuator 904 to the body 902. In the depicted embodiment, the spring-biased interface 948 indirectly couples the actuator 904 to the body 902 through the support arm 946. In an embodiment, the spring-biased interface 948 includes a rod 950 and a spring 952 extending parallel with the rod 950, e.g., concentrically arranged, and biasing a carrier 954. The carrier 954 moves in direction A and compresses the spring 952 to allow the actuator 904 to move to the closed position once the clamp head 906 is in a tightened state relative to the object in the clamping region 908. That is, once compression force exhibited by the clamp head 906 onto the object reaches a critical threshold to overcome the force of the spring 952 against the carrier 954, the spring 952 deflects in direction A to absorb additional travel of the actuator 904 until the actuator 904 reaches the closed position. It should be understood that the spring 952 may also deflect during actuation of the actuator 906 prior to reaching the critical threshold. However, at the critical threshold, all additional force applied to the actuator 904 to move the actuator 904 to the closed position may be taken up by the spring 952.

While the clamp head 906 is in motion, the drill guide 910 can rotate about the rotational axis 944. For example, the adjustment mechanism 938 can link the clamp head 906 and drill guide 910 together. As such, movement of one of the clamp head 906 or drill guide 910 can affect movement of the other one of the clamp head 906 or drill guide 910. As described above, the spring-biased interface 948 allows for continued actuation of the actuator 904 to the closed position after the object is clamped in the clamping region 908. Thus, in certain instances the actuator 904 can move (e.g., from the open position to the closed position) without the clamp head 906 or drill guide 910 moving. In this regard, the drill guide 910 is always referenced to the dimension of the object in the clamping region 908.

For instance, referring again to FIG. 9, the distance D between the clamp face 932 and the support surface 934 is generally set by the size of the object clamped in the clamping region 908. That is, as the actuator 904 is closed, the distance D assumes the dimension of the object contained in the clamping region 908. After the clamp head 906 reaches the tightened state against the object, the actuator 904 can continue to move towards the closed position while the distance D remains unchanged. By rotating the drill guide 910, the angle of the guide axis 912 self-adjusts in view of the distance D set by the object. For narrow objects, e.g., having relatively smaller dimensions in the direction of distance D, the drill guide 910 can assume a steeper angle, i.e., the guide axis 912 can orient more perpendicular to the direction of distance D. For thicker objects, e.g., having relatively larger dimensions in the direction of distance D, the guide axis 912 can assume a shallower angle, i.e., the guide axis 912 can orient to be less perpendicular to the direction of distance D. As the angle of the guide axis 912 relative to the direction of the distance D increases, e.g., as a result of clamping a narrow object, the plunge depth of the drill bit (not illustrated) in the drill guide 910, as measured parallel with respect to the distance D, decreases. Thus, the drill bit does not penetrate through a back side of the object. Conversely, as the angle of the guide axis 912 relative to the direction of the distance D decreases, e.g., as a result of clamping a thick object, the plunge depth of the drill bit (not illustrated) in the drill guide 910, as measured parallel with respect to the distance D, increases. Thus, the drill bit penetrates deeper into the object (without penetrating through the back side of the object) to create a more robust pocket hole.

In an embodiment, movement of the actuator 904 to the closed position causes the drill guide 910 to pivot until the clamp head 906 is in a tightened state against the object in the clamping region 908 after which point the drill guide 910 does not further rotate upon additional movement of the actuator 904. As described above, the lack of additional movement of the drill guide 910 can also be attributed to the adjustment mechanism 138 and the spring-biased interface 948.

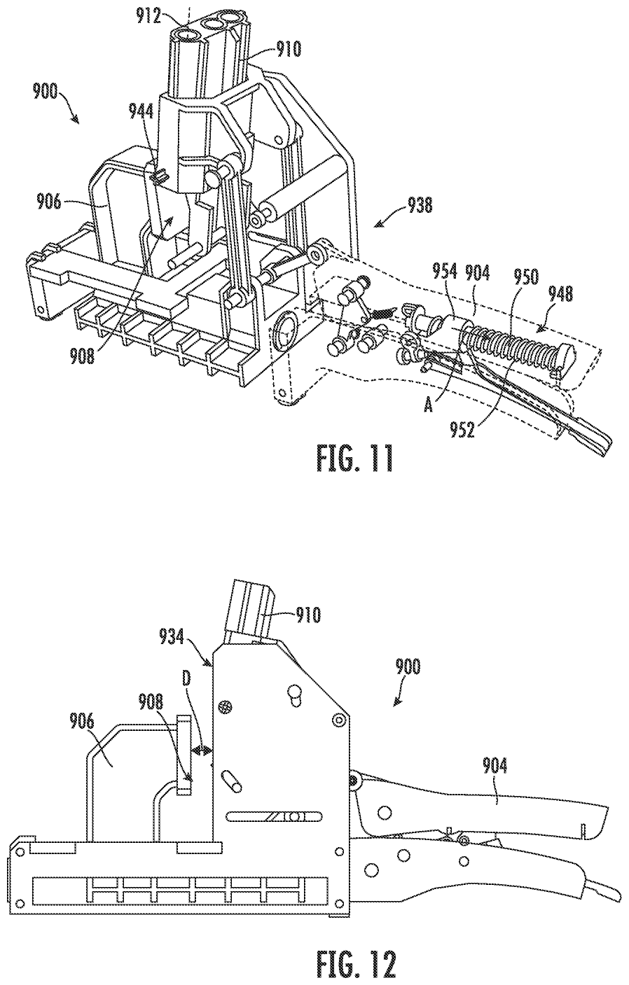

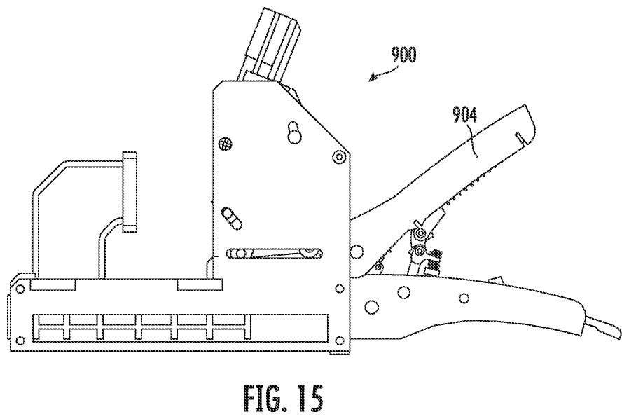

Referring now to FIGS. 12 to 15, side views of the pocket hole jig 900 are provided depicting the pocket hole jig 900 with the actuator in various stages of movement between the closed position (FIG. 12) and the open position (FIG. 15).

Referring initially to FIG. 12, the pocket hole jig 900 is shown with the actuator 904 in the closed position without an object in the clamping region 908. As depicted in FIG. 12, the clamp head 906 is spaced apart from the support surface 934 by a smallest distance D. Meanwhile, the drill guide 910 is oriented at a steepest angle as measured with respect to the distance D.

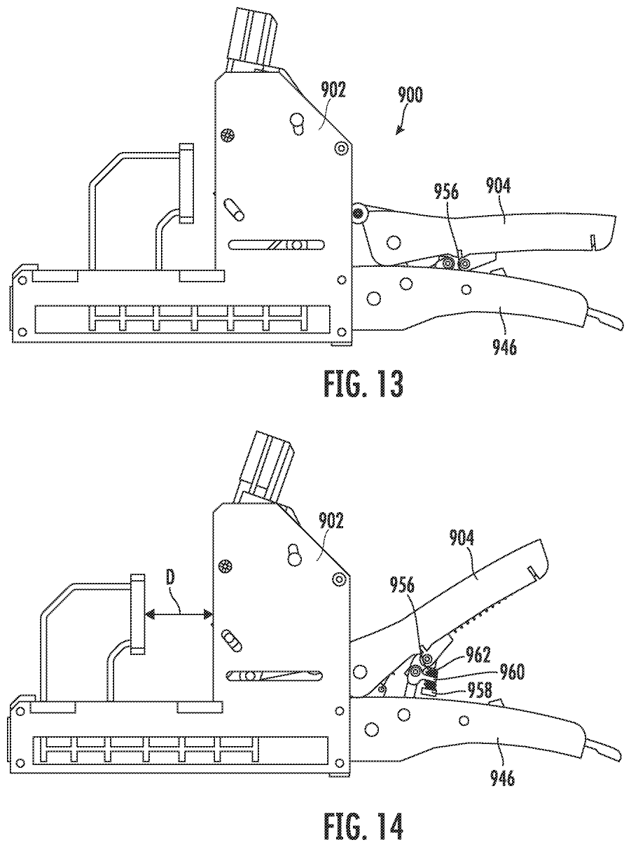

FIGS. 13 and 14 depict the pocket hole jig 900 as the actuator 904 is moved from the closed position towards the open position. As shown, the actuator 904 can be coupled to the support arm 946 or body 902 through an adjustable interface 956 which allows for fine-tuning of the position of the actuator 904. That is, the adjustable interface 956 can allow the operator to set different closed positions. For example, the adjustable interface 956 can include a threaded element 958 which, in combination with a threaded receiver 960 and a stop surface 962, forms a stop against additional travel of the actuator 904. By moving the threaded element 958 relative to the threaded receiver 960, the stop position of the actuator 904 changes. In this regard, the pocket hole jig 900 can be customized by the user based on their hand size, the object being operated on, or both.

As seen in FIGS. 12 to 14, the distance D of the clamping region 908 increases as the actuator 904 is opened. FIG. 15 depicts the pocket hole jig 900 as seen with the actuator 904 in the fully open position. The adjustable interface 956 may generate a tactile indication to the operator when the actuator 904 is in the open position as depicted in FIG. 15. In certain instances, an initial force required to move the actuator 904 from the open position towards the closed position can be greater than the force required at any additional point of travel in the actuator's movement to the closed position.

As depicted in FIGS. 12 to 15, movement of the actuator 904 is performed in a pivotable manner. That is, the actuator 904 moves through rotation. In an embodiment, the pocket hole jig 900 excludes the use of user operable features which move through linear translation. In this regard, the pocket hole jig 900 can be clamped onto an object by pivoting the actuator 904 to the closed position. Once in the closed position, the actuator 904 can lock the clamp head 906 against the object in the clamping region 908 without the use of any secondary locking elements or features. In this regard, the actuator 904 is lockable in the closed position using a single hand.

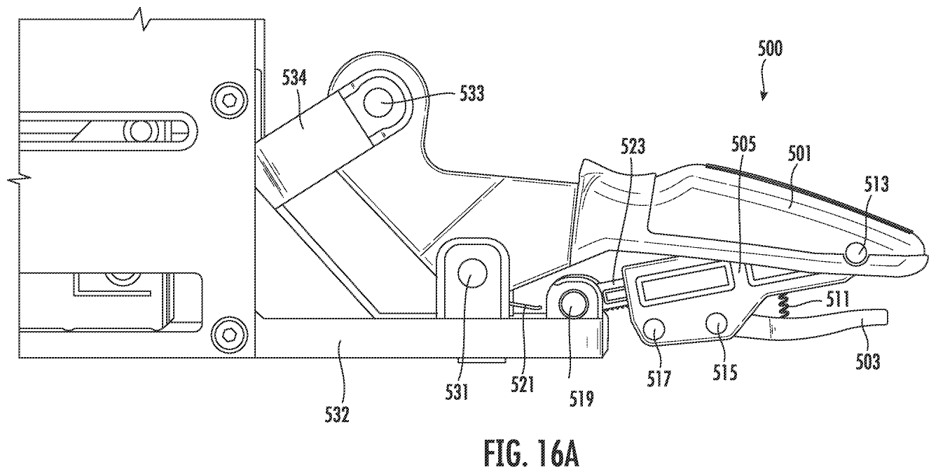

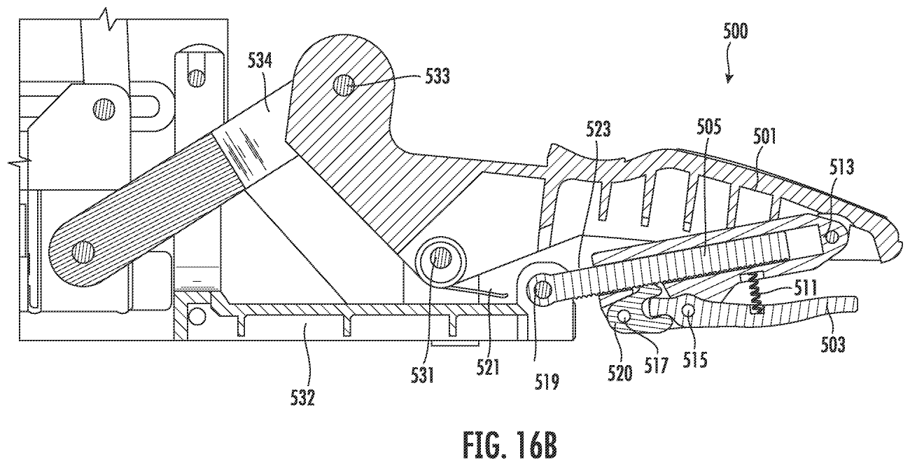

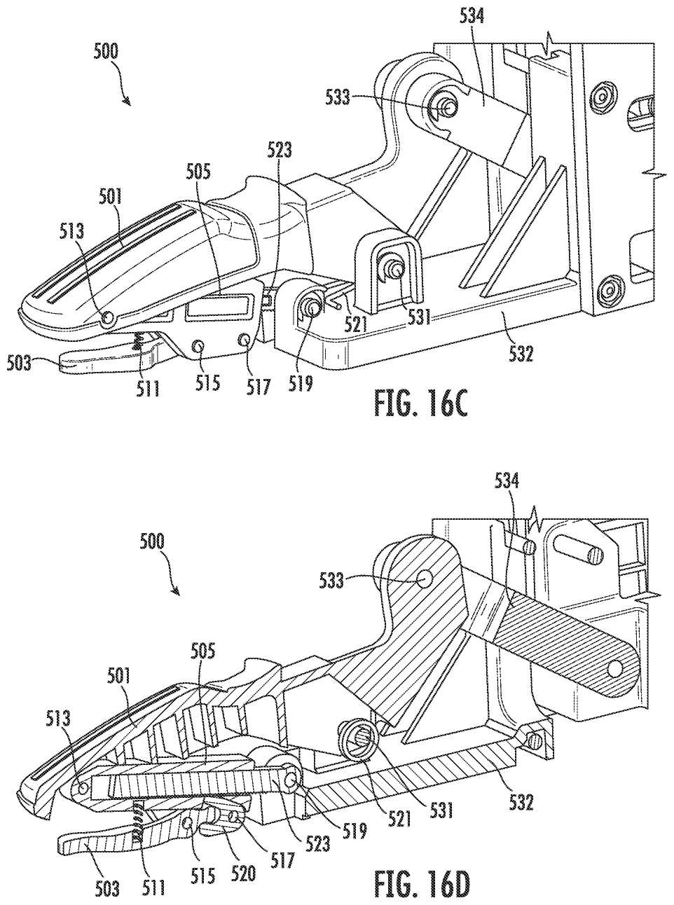

FIGS. 16A-16D show an alternate actuator 500 according to one or more embodiments. Specifically, FIG. 16A shows a side view of the actuator 500, FIG. 16B shows a side cross-sectional view of the actuator 500, FIG. 16C shows a perspective view of the actuator 500, and FIG. 16D shows a perspective cross-sectional view of the actuator 500, according to one or more embodiments. Descriptions of portions that are shown in previous figures are omitted. The actuator 500 includes a handle 501 that includes a gripping portion at a rear thereof, a center portion that is rotatably attached to a base 532 via a hinge 531, and a rear portion that is rotatably attached to a rotatable linkage 534 via a hinge 533. A spring 521 may be formed around the hinge 531 with an end of the spring 521 butting a top surface of the base 532. The gripping portion of the handle 501 is rotatably attached to a rotatable actuator linkage 505 via a hinge 513. A bar 523 is slidably disposed within the rotatable actuator linkage 505, with a rear portion of the bar 523 protruding from the rotatable actuator linkage 505. A rear end of the bar 523 is rotatably attached to the base 532 via a hinge 519. A release lever 503 is rotatably attached to a bottom portion of the rotatable actuator linkage 505 via a hinge 515, and a spring 511 is disposed between a bottom of the rotatable actuator linkage 505 and a top of the release lever 503. A ratchet 517 is rotatably attached to a rear bottom portion of the rotatable actuator linkage 505. According to one or more embodiments, the bar 523 has a ridged bottom surface.

As shown in FIGS. 16B and 16D, a top surface of the ratchet 517 abuts a bottom surface of the bar 523. Thus, friction between the ratchet 517 and the bar 523 prevents relative sliding movement of the bar 523 within the rotating actuator linkage 505, keeping the actuator 500 in position. When a user actuates the actuator 500 by squeezing the release lever 503 towards the handle 501, a front portion of the release lever 503 in front of the hinge 515 rotates upward, while a rear portion of the release lever 503 to the rear of the hinge 515 rotates downward. As the rear portion of the release lever 503 moves downward, a rear end of the release lever 503 that is slotted within the ratchet 520 pushes and rotates a front portion of the ratchet 520 downward, moving the top surface of the ratchet 520 away from the bottom surface of the bar 523, allowing relative sliding movement of the bar 523 within the rotating actuator linkage 505, releasing the actuator 500. This allows a user to push the handle 501 downward such that the front portion of the handle 501 rotates downward about the hinge 531, which in turn rotates the rear portion of the handle 501 upwards about the hinge 531. The upward rotation of the rear portion of the handle 501 pulls a front end of the rotatable linkage 534 upwards and frontwards to actuate the clamp and rotate the drill guide as shown in and described with respect to FIGS. 9-15. Once the user releases the release lever 503, the spring 511 pushes the release lever away from the rotatable actuator linkage 505 so that the rear end of the release lever 503 rotates the ratchet 520 about the hinge 517, and the top surface of the ratchet 520 comes into contact with the bottom surface of the bar 523 to lock the bar 523 within the rotatable actuator linkage 523 via friction. According to one or more embodiments, the frictional forces may be increased via the aforementioned ridged bottom surface of the bar 523. To release the clamp, the user may squeeze the release lever 503 towards the handle 501 to release the actuator 500 without pushing down on the handle 501, and the spring 521 biases the handle 501 towards an unclamped position of the actuator 500.

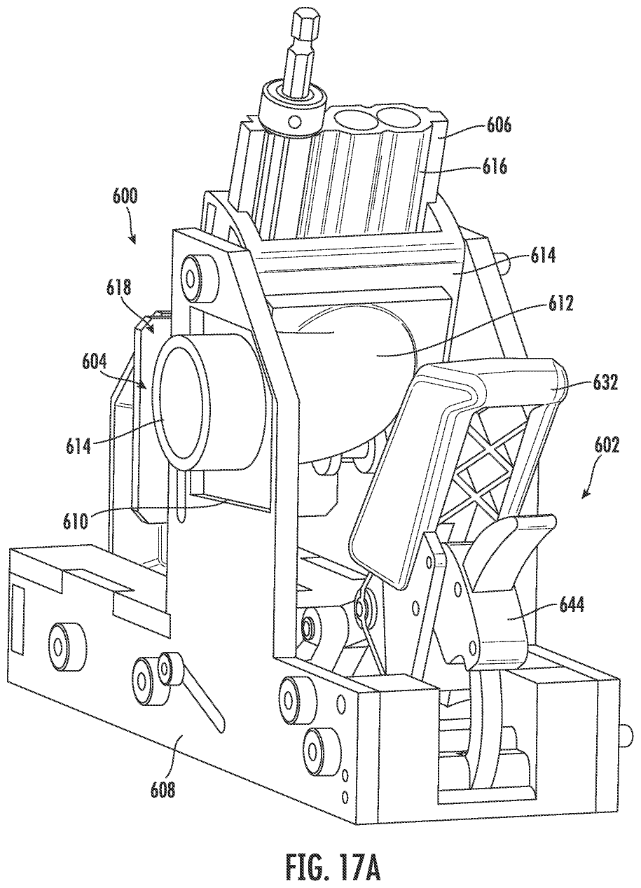

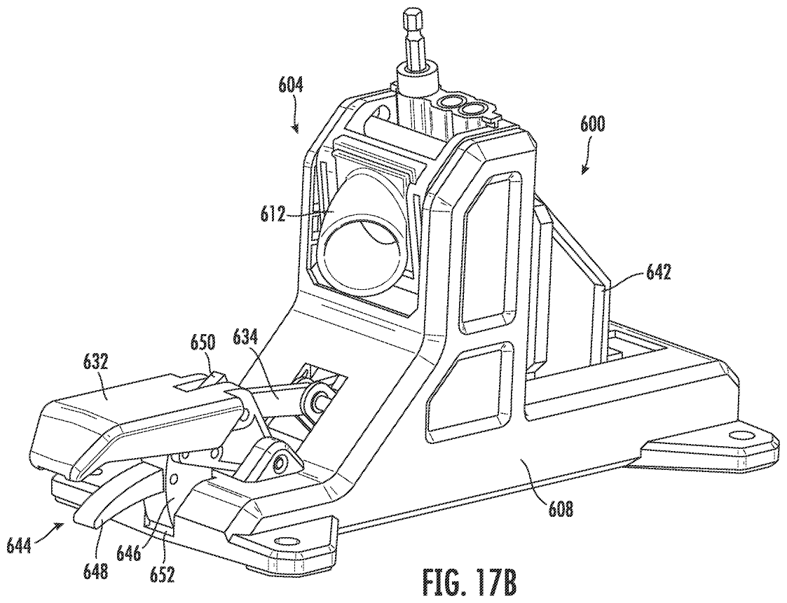

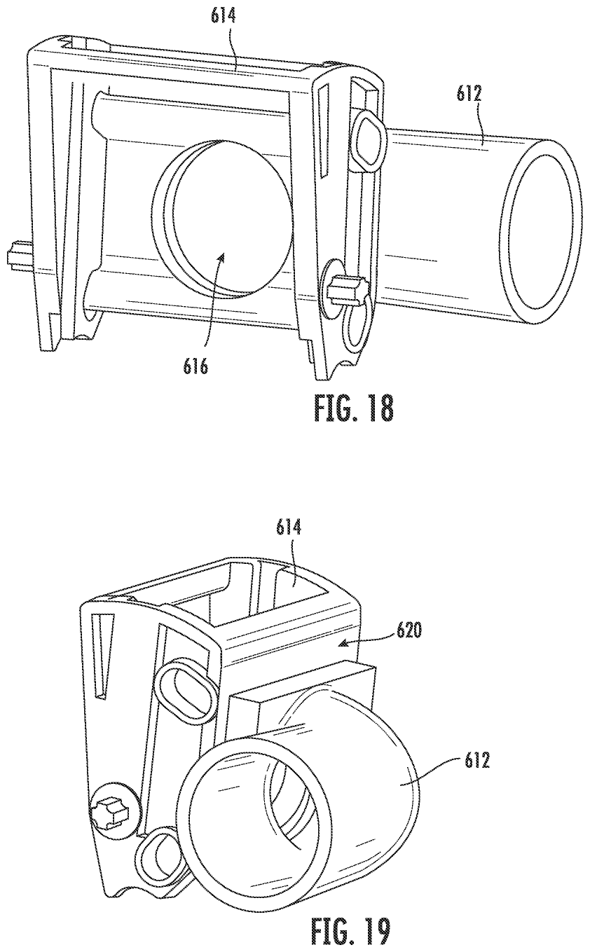

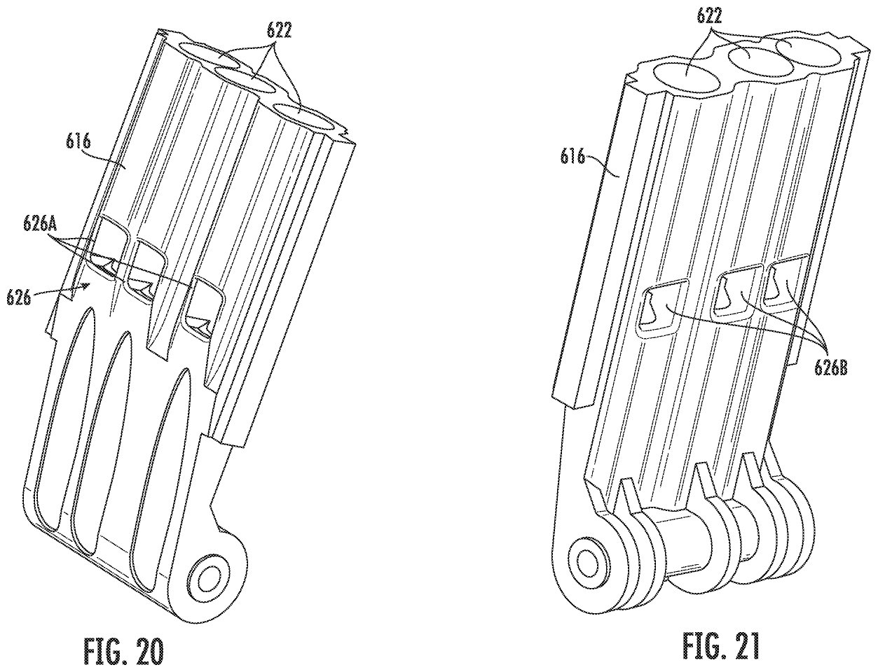

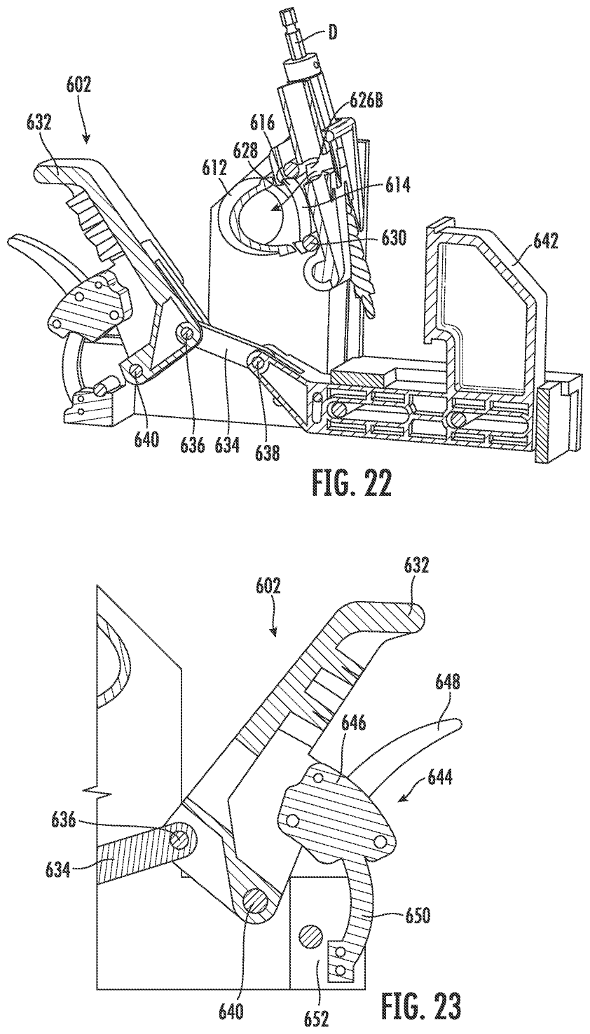

FIGS. 17A-23 show an alternate pocket hole jig 600 including an actuator 602 and a dust extraction element 604 according to one or more embodiments. Specifically, FIGS. 17A and 17B show perspective rear views of the actuator 602 and dust extraction element 604 in accordance with different embodiments, FIG. 18 shows a front end of a drill guide 606 to which the dust extraction element 604 is coupled, FIG. 19 shows a side view of the dust extraction element 604 and drill guide 606, FIG. 20 shows a front perspective view of the drill guide 606, FIG. 21 shows a rear perspective view of the drill guide 606, FIG. 22 shows a cross-sectional perspective view of the pocket hole jig 600, and FIG. 23 shows a side cross-sectional view of the actuator 602 according to one or more embodiments. Descriptions of portions that are shown in previous figures are omitted.

As shown in FIG. 17A, a body 608 of the pocket hole jig 600 can define an opening, such as a cutout 610 through which the dust extraction element 604 can pass. In an embodiment, the dust extraction element 604 can include a conduit 612 in fluid communication with a location of the pocket hole jig 600 where dust and debris are generated as a result of one or more drilling operations. The conduit 612 can have an internal diameter of at least 5 millimeters (mm), such as at least 10 mm, such as at least 20 mm, such as at least 25 mm, such as at least 30 mm, such as at least 35 mm. The conduit 612 can have an outer diameter slightly larger than the internal diameter. In an embodiment, the cutout 610 can be larger than the outer diameter of the conduit 612 to allow for relative movement of the conduit 612 with respect to the body 618 as may be encountered with the drill guide 606 at different angular orientations. In an embodiment, the conduit 612 can freely move relative to the cutout 610. That is, the conduit 612 may not be fixedly coupled to the body 608. In other embodiments, the conduit 612 can be fixed to the body 608 to prevent relative movement therebetween.

In one or more embodiments, the conduit 612 can include a relatively rigid material adapted to maintain sidewall structural integrity under load. For example, the conduit 612 can be formed from a rigid plastic, metal, an alloy, or the like. In other embodiments, the conduit 612 can include a relatively flexible material adapted to deform under load. For example, the conduit 612 can include a portion of flexible hose. The flexible hose can be reinforced, e.g., with an internal wire mesh or helical spring lining or embedded within the hose.

Dust and debris can pass through the conduit 612 to exit the pocket hole jig 600 and prevent buildup of dust and debris on the pocket hole jig 600. In some instances, a terminal end 614 of the conduit 612 can be shaped or sized to receive a hose connection (not illustrated). For example, the terminal end of the conduit 612 can have a tapered shape to allow for installation of the hose connection therewith. The hose connection can be part of a terminal end of a vacuum hose extending from a vacuum generating source. In certain instances, the terminal end can positively engage with the hose connection. For example, the terminal end can include features to form an interference with the hose connection, a bayonet connection, or the like. When active, the vacuum generating source can generate enough suction through the conduit 612 to draw dust and debris from the pocket hole jig 600.

The drill guide 606 can include a carrier 614 and a drill guiding element 616 operably coupled to the carrier 614. The carrier 614 can be coupled to the body 608 in a manner to allow rotation relative to the body 608. The drill guiding element 616 can move relative to the carrier 614.

FIG. 17B illustrates an embodiment of the pocket hole jig 600 where the dust extraction element 604, i.e., the conduit 612 of the dust extraction element 604, does not pass through a cutout 610 like as shown in FIG. 17A, but instead passes around the body 608.

Referring to FIGS. 18 and 19, the carrier 614 can define an aperture 616 through which dust and debris can pass. In an embodiment, the aperture 616 can extend through the carrier 614 in a front-to-back orientation such that dust and debris can escape from a drilling zone 618 (FIG. 17A) to a rear side of the pocket hole jig 600. The illustrated aperture 616 is circular. In other embodiments, the aperture 616 can have another shape, such as a polygonal shape, an ovular shape, an arcuate shape, or a shape including linear and polygonal segments. The aperture 616 can be sized to match or be similar to the internal diameter of the conduit 612 to prevent buildup of dust within the conduit during suction. The conduit 612 can be coupled at or adjacent to a back side 620 of the carrier 614 such that vacuum pressure generated by the vacuum generating source draws dust and debris through the aperture 616 and into the conduit 612. In a particular embodiment, the conduit 612 can be removably coupled to the back side 620 of the carrier 614. For example, the conduit 612 can be coupled to the carrier 614 using one or more fasteners (e.g., threaded fasteners), a slotted interface whereby the conduit 612 is slid on and off rails disposed on the carrier 614, through a bayonet connection, or the like. The conduit 612 may be removable from the carrier 614 for cleaning or inspection.

The conduit 612 can extend from the carrier 614 in a generally horizontal direction. In some instances, the conduit 612 can have a generally L-shaped configuration. In other embodiments, the conduit 612 can define a generally straight shape, can include one or more arcuate portions, can include one or more linear segments, or any combination thereof. Use of a relatively straight, i.e., unbent, shape may reduce drag associated with suction through the conduit 612. The conduit 612 can extend rearward from the carrier 614 and turn to exit the pocket hole jig 600 through the body 608 prior to reaching the actuator 600 (FIG. 17A). Alternatively, the conduit 612 can pass around the body 608 and not extend therethrough (FIG. 17B).

FIGS. 20 and 21 illustrate front and back views of the drill guiding element 616 in accordance with an embodiment. Specifically, FIG. 20 illustrates a front perspective view of the drill guiding element 616 and FIG. 21 illustrates a rear perspective view of the drill guiding element 616 in accordance with an embodiment. The drill guiding element 616 can include insertion openings 622 into which drill bits D (FIG. 22) can be inserted. The drill bits D can enter elongated openings within the drill guiding element 616 through the insertion openings 622 and exit the elongated openings of the drill guiding element 616 at exit openings 624. As the drill bit moves within a workpiece, e.g., wood held by the pocket hole jig 600, dust is generated as material is removed from the workpiece. Left uncollected, the dust, often referred to as sawdust, would accumulate on the pocket hole jig 600 making further use of the pocket hole jig 600 difficult. To mitigate accumulation of dust, the drill guiding element 616 can include vents 626. The vents 626 can be disposed along the length of the elongated openings between the insertion opening 622 and the exit openings 624. In some instances, the drill guiding element 616 includes a plurality of elongated openings. Each one of the elongated openings can include one or more vents 626. Alternatively, the drill guiding element 616 can have a number of vents 626 less than a number of elongated openings. As shown in FIGS. 20 and 21, the drill guiding element 616 includes three elongated openings and three vents 626. The vents 626 can each include a first-side vent 626A and a second-side vent 626B. The first-side vent 626A can be located on a first side of the drill guiding element 616 and the second-side vents 626B can be located on a second side of the drill guiding element 616, where the second side is opposite the first side. Dust generated by the workpiece can pass from the workpiece, through the first-side vents 626A and exit the drill guiding element 616 through the second-side vents 626B. Additionally, dust which is removed from the workpiece through flutings within the drill bit D itself can pass through the second-side vents 626B.

As shown in FIG. 22, the second-side vents 626B can be aligned with the aperture 616 in the carrier 614 such that dust passing through the second-side vents 626B enters the conduit 612 and exits from the pocket hole jig 600 in a direction shown by arrow 628. In some instances, the pocket hole jig 600 can include a sealing element 630, or a plurality of sealing elements, sealing between components of the pocket hole jig 600. Sealed connections can increase suction forces at the vents 626 which can, in turn, increase overall dust and debris removal during drilling operations.

Referring to FIGS. 17A, 17B, 22 and 23, the actuator 602 includes a handle 632 with a gripping portion at a rear thereof, a center portion that is rotatably attached to the body 608 through a rotatable linkage 634 connected to the handle 632 by a first hinge 636 and connected to the body 608 by a second hinge 638. The handle is depicted in FIGS. 17A, 22 and 23 in an unbiased state, as seen with the pocket hole jig 600 in an open state whereby it can receive a workpiece. After a workpiece is inserted into the pocket hole jig 600, the handle 632 is rotated about a pivot axis 640 causing the linkage 634 to pull a clamp head 642 to a closed state against the workpiece (FIG. 17B).

The pocket hole jig 600 can further include a safety 644. The safety 644 can prevent the pocket hole jig 600 from prematurely moving from the open state to the closed state, for example, as a result of an operator accidently applying force to the handle 632. The safety 644 can include an element 646 coupled to the handle 632. In an embodiment, the element 646 is fixedly coupled to the handle 632. A user-engageable portion 648 for a user to grasp the safety 644 can be coupled to the element 646. A locking element 650 can be coupled with the user-engageable portion 648 and extend towards and interfaces with the body 608, or a component coupled therewith, to prevent relative movement of the handle 632 when the user-engageable portion 648 is in the locked state (as shown in FIGS. 17A, 22 and 23). To unlock the safety 644, the user-engageable portion 648 is moved from the locked state by applying force to the user-engageable portion 648. Application of this force causes the user-engageable portion 648 to move towards the handle 632. Simultaneously, the locking element 650 can clear a restriction 652 associated with the body 608, or a component coupled therewith. With the safety 644 in the unlocked state, the operator can then apply pressure on the handle 632 to move the clamp head 642 and tighten the workpiece as shown in FIG. 17B. Once unlocked and after some initial movement of the handle 632, the safety 644 can remain in the unlocked position throughout the remainder of the stroke of the handle 632. The operator can thus release the safety 644 after beginning to tighten the workpiece but before the workpiece is fully tightened. When the handle 632 is returned to the original, unclamped state, the safety 644 can return to the locked state and again prevent movement of the handle 632 until the safety 644 is again depressed.

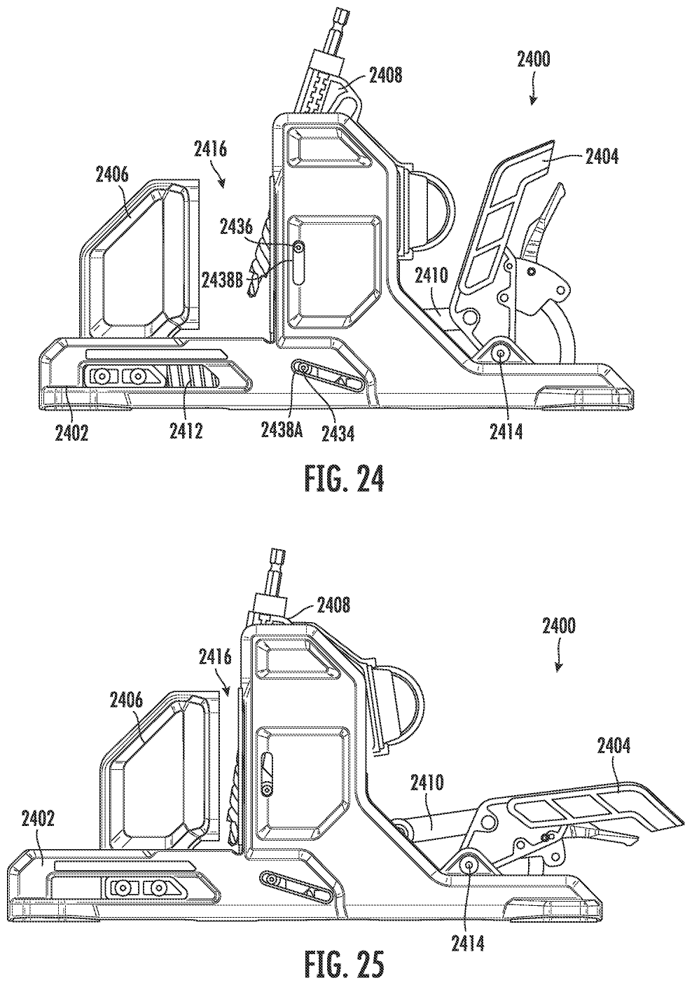

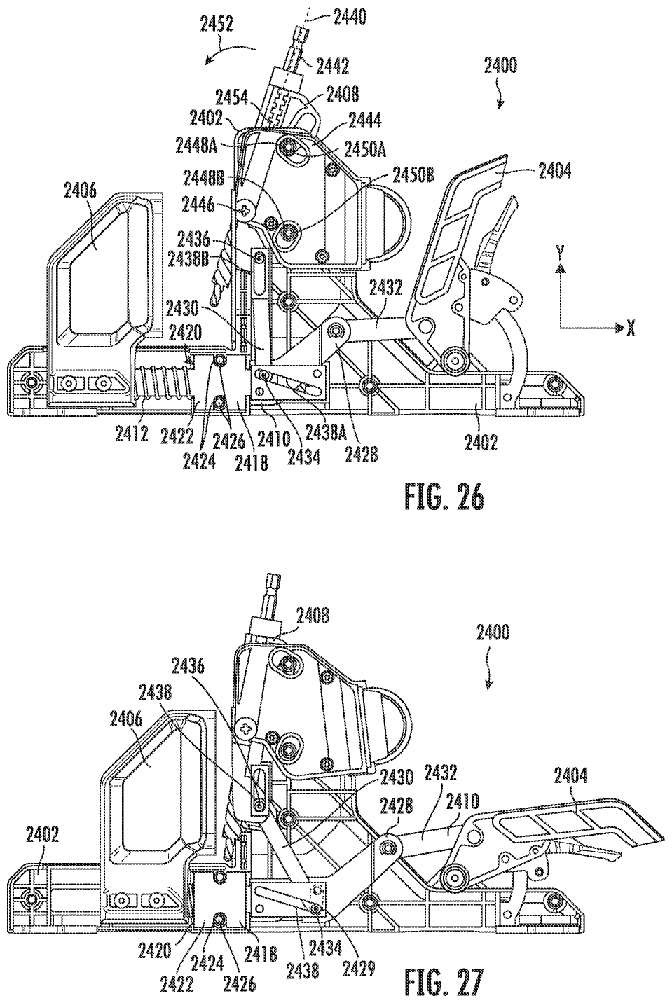

FIGS. 24 to 27 illustrate a pocket hole jig 2400 in accordance with an example embodiment. FIGS. 24 and 26 illustrate the pocket hole jig 2400 in an open state and FIGS. 25 and 27 illustrate the pocket hole jig 2400 in a closed state. FIGS. 24 and 25 depict the pocket hole jig 2400 with a body 2402 and FIGS. 26 and 27 depict the pocket hole jig 2400 with a portion of the body 2402 removed to illustrate internal components of the pocket hole jig 2400. The pocket hole jig 2400 is an automatic pocket hole jig. In an embodiment, the pocket hole jig 2400 can have one or more similar features or attributes as compared to the pocket hole jig 900 described above.

In an embodiment, the pocket hole jig 2400 includes an actuator 2404, a clamp head 2406, a drill guide 2408, a linkage 2410 extending between the actuator 2404 and the clamp head 2406, and a spring 2412. The actuator 2404 extends from the body 2402 and is interfaced by a user to selectively close the pocket hole jig 2400 and lock a workpiece within a clamping region 2416 to the pocket hole jig 2400. The actuator 2404 is movable relative to the body 2402 and can pivot about a pivot point 2414 between a first position (FIG. 24) and a second position (FIG. 25) to move the clamp head 2406 between the open state and the closed state. A workpiece can be inserted into and received in the clamping region 2416 of the pocket hole jig 2400 when the clamp head 2406 is in the open state (i.e., the actuator 2404 is in the first position). The workpiece is secured within the clamping region 2416 by moving the actuator 2404 from the first position to the second position. In an embodiment, the clamp head 2406 moves towards the actuator 2404 when the clamp head 2406 is moved to the closed state. As described below, the actuator 2404 can be locked in the second position to secure the workpiece within the clamping region 2416. The second (locked) position of the actuator 2404 is different for different sized workpieces. Large workpieces require less movement of the actuator 2404 from the first position while small workpieces require greater movement of the actuator 2404 from the first position. To release the workpiece from the clamping region 2416, the actuator 2404 is unlocked and moved towards the first position. The workpiece may be releasable from the clamping region 2416 prior to the clamp head 2406 reaching the fully open state, i.e., prior to the actuator 2404 being moved to the first position (FIG. 24).

The spring 2412 can bias the actuator 2404 from the second position to the first position, for example by biasing the clamp head 2406 towards the open state. In an embodiment, the spring 2412 is disposed between a spring stop 2418 and the clamp head 2406. The spring stop 2418 can be fixed relative to the body 2402. In an embodiment, the spring stop 2418 can be at least partially disposed within the body 2402. The spring stop 2418 can define a spring seat 2420 supporting an axial end of the spring 2412. In an embodiment, the spring stop 2418 can be unitary with the body 2402. For example, the body 2402 can be formed by a molding process, such as injection molding, and the spring stop 2418 can be molded on the body 2402 during the molding process. In another embodiment, the spring stop 2418 includes a discrete (separate) body coupled to the body 2402, e.g., by one or more fasteners. In the depicted embodiment, the spring stop 2418 includes a discrete body 2422 defining two slots (or openings) 2424 each receiving a fastener 2426 therethrough to mitigate movement of the spring stop 2418. The fasteners 2426 are coupled to the body 2402 and retain the spring stop 2418 at a relatively fixed position with respect to the body 2402. In some instances, the fasteners 2426 can include discrete bodies, such as one or more threaded or non-threaded fasteners that extend into or through the slots 2424. In other instances, the fasteners 2426 can be unitary with the body 2402 including, e.g., one or more projections formed during the molding process of the body 2402 that extend into or through the slots 2424.

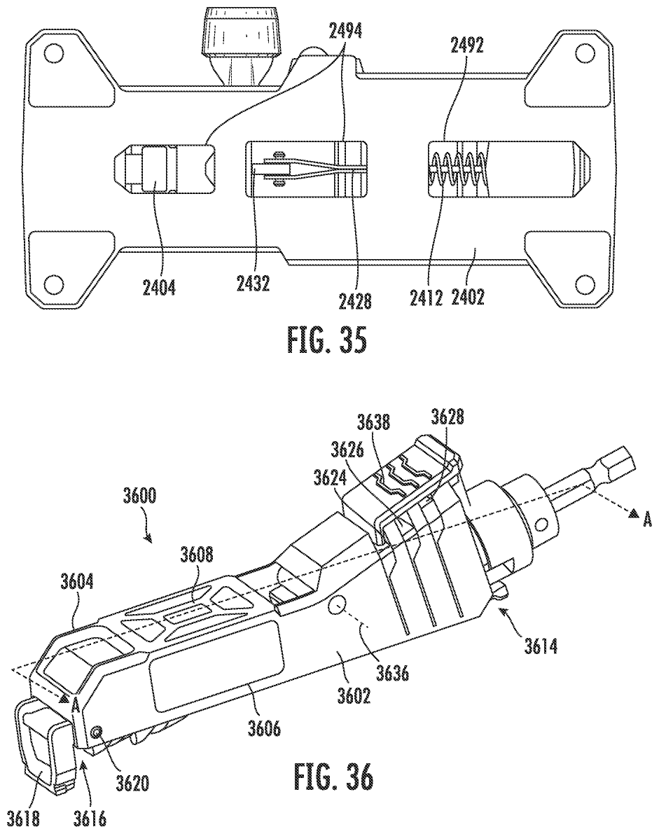

As described above, the linkage 2410 extends from the clamp head 2406 to the actuator 2404. The linkage 2410 can further extend to the drill guide 1408. The linkage 2410 can include a plurality of linkage segments, referred to as links, that operably couple the actuator 2404 to the clamp head 2406 and the drill guide 2408 to allow the actuator 2404 to affect movement of the clamp head 2406 and the drill guide 2408. In an embodiment, at least one of the links can be formed from a single (unitary) piece. In another embodiment, at least one of the links can be formed from a plurality of pieces (see, e.g., FIG. 35 illustrating a first link 2428 including a plurality of separate components disposed adjacent to one another). The links can be coupled together through dynamic interfaces that allow for relative movement between the links. The dynamic interfaces can permit relative rotational movement, translational movement, or both.

The links can include the first link 2428 coupled to the clamp head 2406, a second link 2430 coupled to the first link 2428 and coupled to the drill guide 2408, and a third link 2432 coupled to the first link 2428 and coupled to the actuator 2404. In an embodiment, the first link 2428 can be statically coupled to the clamp head 2406. For instance, the first link 2428 can be coupled to the clamp head 2406 by a plurality of fasteners extending through the clamp head 2406 that interface with the first link 2428 and secure the first link 2428 to the clamp head 2406 at a fixed orientation. The second link 2430 can be rotatably coupled to the first link 2428 and rotatably coupled to the drill guide 2408. In an embodiment, the second link 2430 can also be translatable relative to the first link 2428. For example, the first link 2428 can include a slot 2429 (FIG. 27) in which a guide element 2434 (described below) of the second link 2430 can move.

The third link 2432 can be rotatably coupled to the first link 2428 and rotatably coupled to the actuator 2402. As the actuator 2402 pivots about the pivot point 2414 from the first position (FIG. 26) to the second position (FIG. 27), the third link 2432 pulls on the first link 2428 to move the clamp head 2406 towards the closed position. The first link 2428 also pulls on the second link 2430 to move the drill guide 2408 from a first drill guide position (FIGS. 24 and 26) towards a second drill guide position (FIGS. 25 and 27). Conversely, as the actuator 2402 pivots about the pivot point 2414 from the second position to the first position, the third link 2432 pushes on the first link 2428 to move the clamp head 2406 towards the open position. The first link 2428 also pushes on the second link 2430 to move the drill guide 2408 from the second drill guide position towards the first drill guide position.

In an embodiment, the first link 2428 can move along a linear path in response to rotational movement of the actuator 2402. In an embodiment, the first link 2428 extends through the spring stop 2418, e.g., through an opening (not illustrated) in the spring stop 2418, and reciprocates between a first position (FIG. 26) and a second position (FIG. 27) as the actuator 2402 is moved between the first and second positions, respectively. In an embodiment, the spring stop 2418 at least partially defines a pathway along which the first link 2428 moves. Limitations to movement of the first link 2428 can be defined at least in part by the spring stop 2418, the body 2402 interfacing with the clamp head 2406, limits of movement at the actuator 2404, or limits of movement of the second link 2430. In an embodiment, a portion of the first link 2428 extends through the spring 2412. The first link 2428 can retain and guide the spring 2412 between compressed and elongated states as the clamp head 2406 moves between the closed and open states.

As depicted in FIGS. 26 and 27, the second link 2430 is rotatable with respect to both the first and third links 2428 and 2432. As the first link 2428 is moved in a direction away from the clamp head 2406 (i.e., towards the second position depicted in FIG. 27), the second link 2430 can rotate. Rotation of the second link 2430 can tracked (guided). For example, the second link 2430 can include a first guide element 2434 disposed at a first end of the second link 2430 and a second guide element 2436 disposed at a second end of the second link 2430. By way of example, the first and second guide elements 2434 and 2436 can include pins projecting from the second link 2430. The first and second guide elements 2434 and 2436 can each be statically coupled to the second link 2430 (e.g., unitary therewith) and track within, i.e., be guided by, guiding features, such as slots 2438. In an embodiment, the slots 2438 are formed in the body 2402. The slots 2438 can extend into, or through, the body 2402. That is, the slots 2438 may be recessed into the body 2402 or include apertures extending fully through a sidewall of the body 2402. The guiding features 2434 and 2436 are not intended to be limited to slots and can alternatively include any one or more of ramps, recesses, or other guide features that guide a motion path of the second link 2430 relative to the body 2402. Moreover, in an embodiment, the guide elements 2434 and 2436 and slots 2438 can be reversed such that the slots 2438 are disposed in the second link 2430 and the guide elements 2434 and 2436 are disposed in the body 2402. The guide elements 2434 and 2436 and slots 2438 may be mirrored on both sides of the body 2402 (i.e., opposite sides of the linkage 2410).

The slots 2438 can include a plurality of slots, such as a first slot 2438A and a second slot 2438B. The first slot 2438A can interface with the guiding feature 2434 and the second slot 2438B can interface with the guiding feature 2436. In an embodiment, the first and second slots 2438A and 2438B can be angularly offset from one another such that a guiding path formed by the first and second slots 2438A and 2438B guides the second link 2430 in a manner to cause the drill guide 2408 to reorient relative to the body 2402 of the pocket hole jig 2400 based on the size of the receiving area 2416 (i.e., the size of a workpiece actively disposed in the receiving area 2416). For example, the second slot 2438B can extend in a generally vertical direction (shown by a Y-axis in FIG. 26), as seen when the pocket hole jig 2400 is placed on a horizontal surface and the first slot 2438A can be angularly offset from the vertical direction. In an embodiment, the first slot 2438A can be angularly offset from the vertical direction (Y-axis) by at least 10°, such as at least 20°, such as at least 30°, such as at least 40°, such as at least 50°, such as at least 60°. The first and second slots 2438A and 2438B can also define different lengths (i.e., distances along which the guiding features 2434 and 2436 travel) as compared to one another. For example, the first slot 2438A can be longer than the second slot 2438B. In an embodiment, the length of the first slot 2438A can be at least 5% greater than the length of the second slot 2438B, such as at least 10% greater, such as at least 15% greater, such as at least 20% greater. The lengths and angles of the first and second slots 2438A and 2438B relative to each other and relative to the body 2402 of the pocket hole jig 2400 can be determined to properly reposition and align the clamp head 2406 and the drill guide 2408 based on movement of the actuator 2404.

The drill guide 2408 defines a guide axis 2440 for a drill bit 2442. As the size of the workpiece in the clamping region 1416 changes, the relative angle of the guide axis 2440, and the resulting pocket holes drilled into the workpiece, changes. For instance, thinner workpieces require steeper hole orientations than wider workpieces. By adjusting the angle of the drill guide 2408 while adjusting the size of the clamping region 1416, i.e., moving the clamp head 2406 towards the drill guide 2408, the pocket hole jig 2400 automatically adjusts to accommodate different sized workpieces, removing the need for any guesswork or calculations to properly angle the pocket holes.

In an embodiment, the drill guide 2408 is indirectly coupled to the body 2402 of the pocket hole jig 2400 through a carriage 2444. The carriage 2444 can move relative to the body 2402. For example, the carriage 2444 can pivot relative to the body 2402 about a pivot point 2446. The carriage 2444 can also include one or more slots 2448, such as a first slot 2448A and a second slot 2448B, that track along guiding features 2450, such as a first guiding feature 2450A and a second guiding feature 2450B. The guiding features 2450 restrain movement of the carriage 2444 and maintain the carriage 2444 within a defined range of movement. In an embodiment, the guiding features 2450 can be part of the body 2402. In another embodiment, the guiding features 2450 can include secondary structures, such as fasteners, coupled to the body 2402. The guiding features 2450, or at least one of the guiding features 2450, can extend through the carriage 2444 and the drill guide 2408. As the second link 2430 is pulled by movement of the actuator 2404 from the first position to the second position, the carriage 2444 pivots about the pivot point 2446 in a direction 2452 as guided by the guiding features 2450. As the carriage 2444 rotates about the pivot point 2446 in the direction 2452, the guide axis 2440 gets steeper relative to the clamping region 2416. Conversely, as the carriage 2444 rotates about the pivot point 2446 in a direction opposite to the direction 2452, the guide axis 2440 gets shallower relative to the clamping region 2416. Movement of the actuator 2404 causes the carriage 2444 and the drill guide 2408 to move in a prescribed roto-translational movement in view of the guiding components described above (e.g., the slots 2438, the guiding features 2450, etc).

The carriage 2444 can be indirectly coupled to the second link 2430 through the drill guide 2408. In an embodiment, the drill guide 2408 is coupled to the second link 2430 and moves within a tracked (guided) portion of the carriage 2444. As the drill guide 2408 is moved within the tracked portion of the carriage 2444, the spatial constraints created on the carriage 2444 as a result of the pivot point 2446, the slots 2448, and the guiding features 2450 cause the carriage 2444 to rotate about the pivot point 2446. Simultaneously, the drill guide 2408 moves (translates) relative to the carriage 2444, guided by a tongue and groove 2454 or other similar tracked (guided) structure therebetween.

As described above, the actuator 2404 is lockable in one or more relative positions in one or both directions of travel. In an embodiment, the actuator 2404 is lockable in one direction of travel. The actuator 2404 may be free to move in a direction towards the second position (closing the clamping region 2416) and be selectively locked in a direction away from the second position (opening the clamping region 2416).

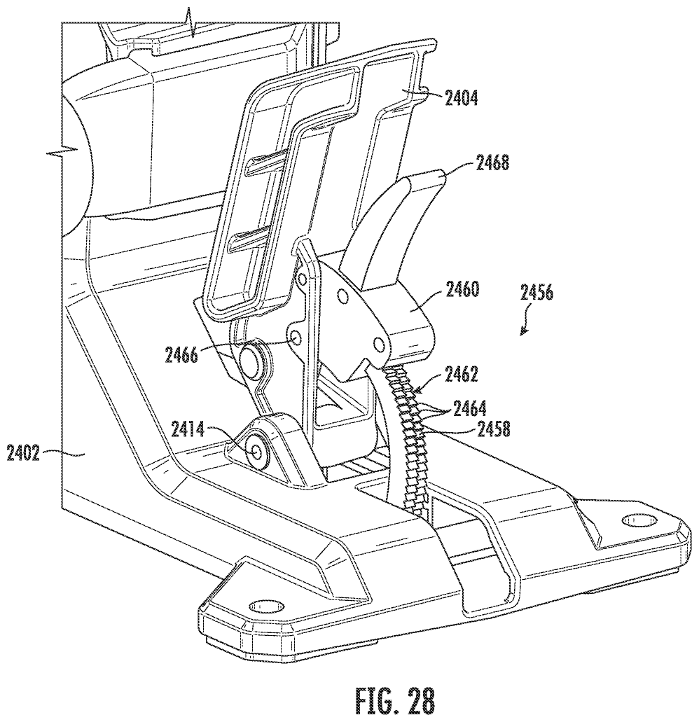

FIG. 28 illustrates a portion of the pocket hole jig 2400 as seen in accordance with an embodiment. In particular, FIG. 28 illustrates the actuator 2404 and a locking protocol associated therewith. The locking protocol is formed by a lockable structure 2456 including, for example, a ratchet bar 2458 and a lock 2460 configured to interface with the ratchet bar 2458. The ratchet bar 2458 can be coupled to the body 2402. For example, the ratchet bar 2458 can be fixedly coupled to the body 2402 such that the ratchet bar 2458 is static relative to the body 2402. The ratchet bar 2458 can include a curved surface 2462 defining one or more engagement features, such as a plurality of teeth 2464. In an embodiment, the curved surface 2462 of the ratchet bar 2458 can have a radius of curvature with an origin at the pivot point 2414.

As the actuator 2404 moves between the first and second positions, the lock 2460 translates relative to the ratchet bar 2458 such that a locking feature of the lock 2460 (e.g., a sprung latch) interfaces with the teeth 2464. In an embodiment, the locking feature can be maintained in contact with the teeth 2464 along the entire movement of the actuator 2404. In another embodiment, the locking feature can be interfaced with the teeth 2464 when the actuator 2404 reaches, or substantially reaches, the second position. It should be understood that the second position may differ based on the size of the workpiece in the receiving area 2416. Once the actuator 2404 reaches the second position, the locking feature of the lock 2460 can interface with a nearest tooth 2464 to prevent the actuator 2404 from returning to the first position, thereby locking the actuator 2404 in the second position.

In an embodiment, the ratchet bar 2458 includes a plurality of rows of teeth 2464, such as two rows of teeth 2464. The teeth 2464 in each of the rows can be staggered relative to one another along a length of the ratchet bar 2458. The locking feature of the lock 2460 can interface with any (either) row of the teeth 2464. In such a manner, the actuator 2404 can have finer locking tolerance to the workpiece without requiring a reduction in the size of the teeth 2464 to accommodate additional teeth 1464 along the surface 2462 of the ratchet bar 2458.

The lock 2460 can be movably coupled to the actuator 2404, such as at a pivotable interface 2466. The lock 2460 can include a handle 2468 that allows the lock 2460 to be pivoted about the pivotable interface 2466. A spring (not illustrated) can bias the lock 2460 about the pivotable interface 2466 towards the ratchet bar 2458 such that the locking features of the lock 2460 are in contact with the teeth 2464 when the handle 2468 is not subjected to loading. The handle 1468 can be moved away from the teeth 2464 to pivot the lock 2460 from a locked state, where the locking features of the lock 2460 are in contact with the teeth 2464, to an unlocked state, where the locking features of the lock 2460 are not in contact with the teeth 2464. With the lock 2460 in the unlocked state, the actuator 2404 can be moved towards the first position or towards the second position. With the lock 2460 in the locked state, the actuator 2404 can be moved towards the second position but not the first position. Force required to move the actuator 2404 is generally consistent until the workpiece is at, or nearing, a locked state in the clamping region 2416. The operator of the pocket hole jig 2400 can terminate movement of the actuator 2404 when the force required to move the actuator 2404 rapidly increases, indicative of a locked workpiece. Once the workpiece is locked, the operator can simply release the actuator and the workpiece remains in the locked state in the clamping region 2416.

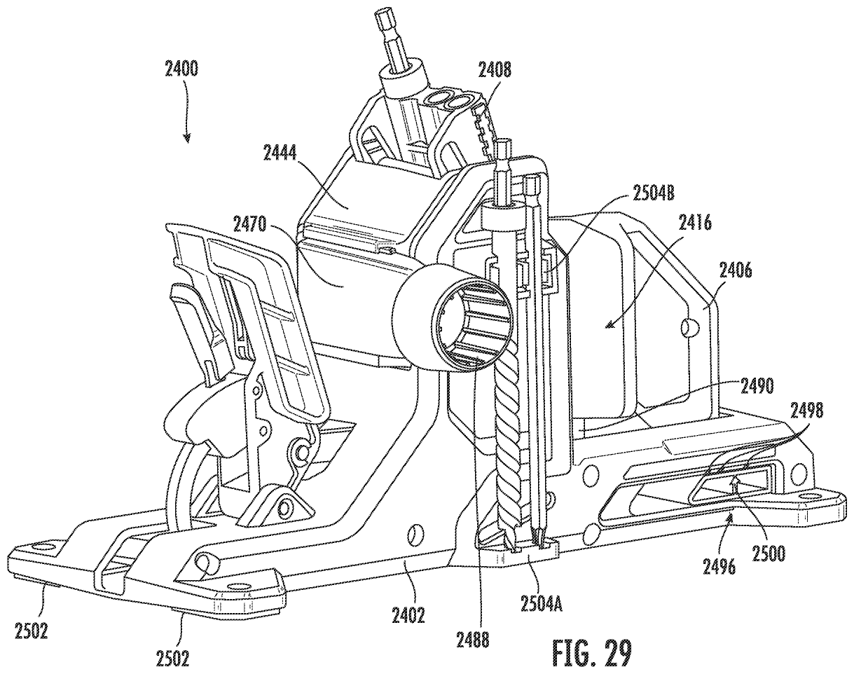

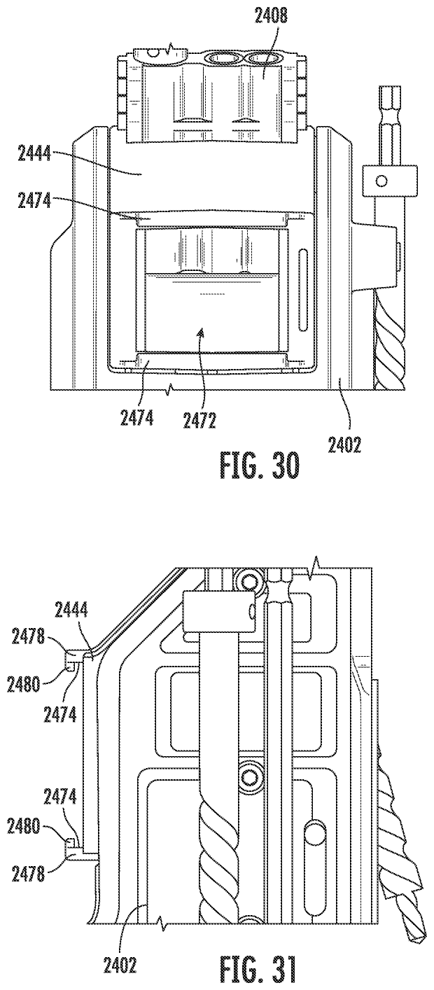

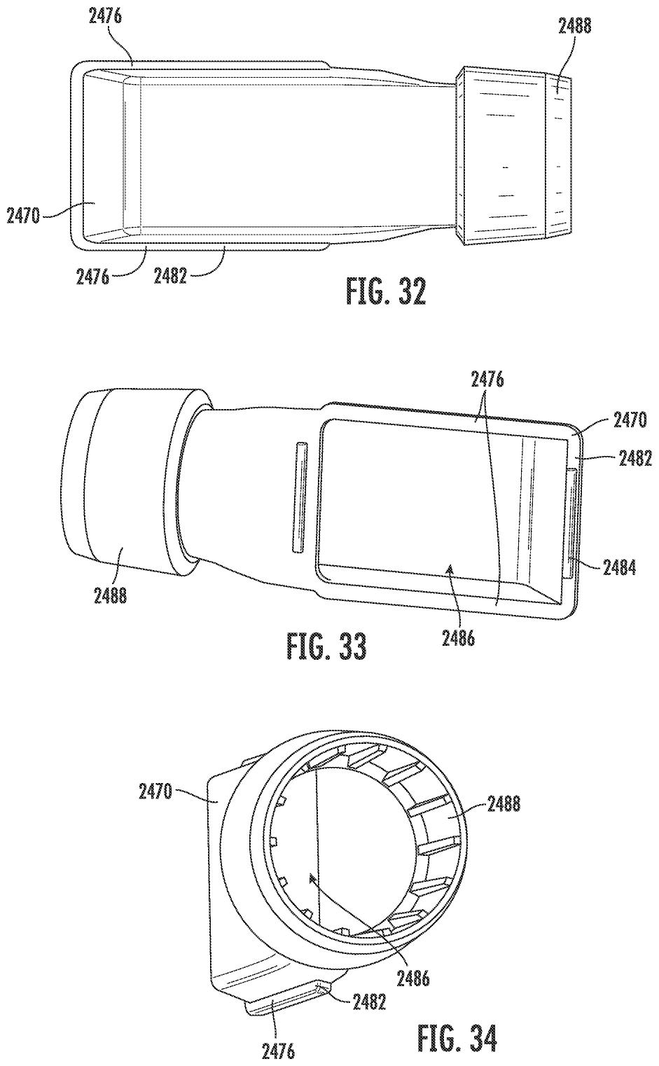

Dust and debris are generated when the pocket hole jig 2400 is in use (i.e., a workpiece is disposed in the receiving area 2416 and a drill bit is actively boring into the workpiece). The pocket hole jig 2400 can include features and components to assist with dust extraction to prevent dust from building up in the clamping region 2416 or within the body 2402 of the pocket hole jig 2400. Referring to FIGS. 29 to 34, the pocket hole jig 2400 can include a dust extractor including, e.g., a dust port, such as a vacuum attachment port 2470 that allows the pocket hole jig 2400 to communicate with a vacuum (not illustrated) to extract dust from the body 2402. The vacuum attachment port 2470 may removably interface with the carriage 2444. The carriage 2444 can include an opening 2472 in communication with the receiving area 2416, the drill guide 2408, or both such that the vacuum attachment port 2470 is fluidly coupled to the clamping region 2416 or the drill guide 2408 when the vacuum attachment port 2470 is coupled to the carriage 2444.

The vacuum attachment port 2470 can be coupled to the carriage 2444 through a quick attachment interface 2474 disposed on the carriage 2444 adjacent to the opening 2472. The vacuum attachment port 2470 can include a complementary quick attachment interface 2476 that interfaces with the quick attachment interface 2474. The quick attachment interface 2474 and complementary quick attachment interface 2476 permit quick attachment and detachment of the vacuum attachment port 2470 relative to the carriage 2444. By way of example, the quick attachment interface 2474 can include a plurality of rails 2478 disposed on opposite sides of the opening 2472. The rails 2478 can be unitary with the carriage 2444. The rails 2478 can each include a lip 2480. The rails 2478 and lips 2480 can define grooves. The vacuum attachment port 2470 includes one or more tongues 2482 that interface with the grooves of the carriage 2444. In some embodiments, the one or more tongues 2482 can include a single tongue. The single tongue can extend continuously along a perimeter of the vacuum attachment port 2470. In other embodiments, the one or more tongues 2482 can include a plurality of tongues. The tongues can be spaced apart from one another and extend along the perimeter of the vacuum attachment port 2470. The tongue(s) 2482 of the vacuum attachment port 2470 can translate (slide) relative to the grooves of the carriage 2444 to allow for quick attachment and detachment of the vacuum attachment port 2470 to the carriage 2444.

In an embodiment, the vacuum attachment port 2470 includes a stop feature 2484 configured to indicate when the vacuum attachment port 2470 is properly aligned with respect to the carriage 2444 such that the opening 2472 in the carriage 2444 is in fluid communication with an aperture 2486 in the vacuum attachment port 2470. In some instances, the stop feature 2484 can include a ridge extending from the vacuum attachment port 2470. The ridge can snap onto a complementary feature in the carriage 2444, such as a channel or a complementary ridge, when the vacuum attachment port 2470 is properly aligned. The stop feature 2484 can act as a detent to prevent detachment of the vacuum attachment port 2470 from the carriage 2444 during use of the pocket hole jig 2400.

In an embodiment, the above-described structure can be reversed such that the vacuum attachment port 2470 defines one or more grooves in which a tongue of the carriage 2444 is received. Alternatively, or in addition, the attachment interface can otherwise be adjusted, rearranged or reconfigured to include any other known quick attachment protocols. Yet further, in some instances, the vacuum attachment port 2470 can be fixed to the carriage 2444 by a non-quick attachment protocol, such as via one or more fasteners, an adhesive, a weld, or the like. Additionally, the vacuum attachment port 2470 may be coupled to the body 2402 instead of, or in addition to, attachment to the carriage 2444.

When attached to the pocket hole jig 2400, the aperture 2486 of the vacuum attachment port 2470 can extend from the opening 2472 in the carriage 2444 to a nozzle 2488. The nozzle 2488 can be sized to interface with a vacuum hose coupled to a vacuum which generates suction. In an embodiment, the nozzle 2488 can define an internal dimension that interfaces with a vacuum hose having a first size (e.g., 1.25 inch diameter) and an outer dimension that interfaces with a vacuum hose having a second size different than the first size (e.g., 1′/s inch diameter).

In an embodiment, the vacuum attachment port 2470 is reconfigurable relative to the body 2402 between a plurality of different orientations. For example, the vacuum attachment port 2470 can be reversible relative to the body 2402 and installed with the nozzle 2488 oriented towards a left side of the body 2402 or a right side of the body 2402. By way of example, the tongue 2482 can be inserted into and slide relative to the grooves in the carriage 2444 in either direction. Reversibility allows the pocket hole jig 2400 to be used in a wide range of applications and environments and provides easier use by both left-handed and right-handed operators.

To further assist in dust and debris management, the pocket hole jig 2400 can further include one or more openings that extend through the body 2404 to permit dust discharge from the receiving area 2416. For example, the body 2402 can include an ingress opening 2490 (FIG. 29) in fluid communication with the clamping region 2416. In certain instances, the clamp head 2406 can extend from the body 2402 through, and move relative to, the ingress opening 2490. The ingress opening 2490 can allow dust to move from the clamping region 2416 into the body 2402. The body 2402 can further include an egress opening 2492 (FIG. 35) in fluid communication with the ingress opening 2490 to allow dust to move from inside the body 2402 to outside the body 2402. In an embodiment, the egress opening 2492 is disposed below the ingress opening 2490, such as for example, directly below the ingress opening 2490. As depicted in FIG. 35, the body 2402 can include one or more additional egress openings 2494 configured to allow discharge of dust from the body 2402 during use of the pocket hole jig 2400. The additional egress opening(s) 2494 can be located near moving components to prevent buildup of dust that might interfere with movement of the components, such as for example, the links (e.g., the first and third links 2424 and 2432), the spring 2412, and the actuator 2404. In some instances, the body 2402 of the pocket hole jig 2400 can be raised from an underlying supporting surface by one or more legs or pads 2502 (FIG. 29). Dust and debris may thus more easily pass through the egress openings 2492 and 2494.

The pocket hole jig 2400 can include features that allow an operator to quickly reference information about the pocket holes formed in a workpiece. Referring to FIG. 29, the pocket hole jig 2400 can include an indicator 2496 that indicates a size of a fastener to be used in a pocket hole drilled in the workpiece using the pocket hole jig 2400. The indicator 2496 can indicate the size of the fastener based on the relative size of the workpiece contained in the clamping region 2416. For example, the indicator 2496 can include indicia 2498 disposed on the body 2402 and a marker 2500 disposed on the clamp head 2406. As the clamp head 2406 moves relative to the body 2402, the marker 2500 moves relative to the indicia 2498. In some instances, the marker 2500 can move in a 1:1 ratio with movement of the clamp head 2406. For example, the marker 2500 can be fixed relative to the clamp head 2406 or even be unitary with the clamp head 2406. As the clamp head 2406 moves, the marker 2500 can signal to an operator an appropriate fastener size based on where the marker 2500 is located relative to the indicia 2498. In some instances, the indicia 2498 can label the fastener sizes using imperial or metric units (e.g., 1¼″ fastener, 1½″ fastener, 25 mm fastener, 37.5 mm fastener, etc.). In other instances, the indicia 2498 can use a different unit of measurement or allow the operator to manually measure fastener size using a comparison or measurement created by the indicia 2498. The indicia 2498 can include, for example, hash marks or lines that are each labeled with the different sized fasteners. After the workpiece is secured in the clamping region 2416, the operator can determine which hashmark or line the marker 2500 aligns with, or best aligns with, the marker 2500 and select the appropriately sized fastener accordingly.

The pocket hole jig 2400 can include storage areas for drill bits, driver bits, and other implements used with, or as part of using, the pocket hole jig 2400. Referring to FIGS. 29 and 31, the body 2402 of the pocket hole jig 2400 can include attachment structures 2504A and 2504B (collectively referred to as structures 2504) that interface with one or more implements to store the implement(s) on the body 2402. In an embodiment, the attachment structure 2504A includes a tray with one or more recessed areas. The tray can support an axial end of the implement(s) with the recessed areas maintaining the axial ends of the implements at a relatively fixed position. The attachment structure 2504B can include receiving areas where the implement(s) are received and movement of the implement(s) is selectively restrained. In an embodiment, the receiving areas are formed between deflectable fingers or other types of snap interfaces that allow for lateral introduction and removal of the implement(s) from the receiving area. The implement(s) can be installed and removed from the structure 2504 without requiring removal of any fasteners, latches, clasps, etc. The operator can tilt the implement(s) relative to the structure 2504 to release the implement(s) from one of the attachment structures 2504A or 2504B and then further move the implement(s) to release it from the other of the attachment structures 2504A or 2504B. Alternatively, or in addition, the implement(s) can be released from the structure 2504 by sliding the implement(s) along their axis. Installation of the implement(s) to the structure 2504 can be performed in reverse.

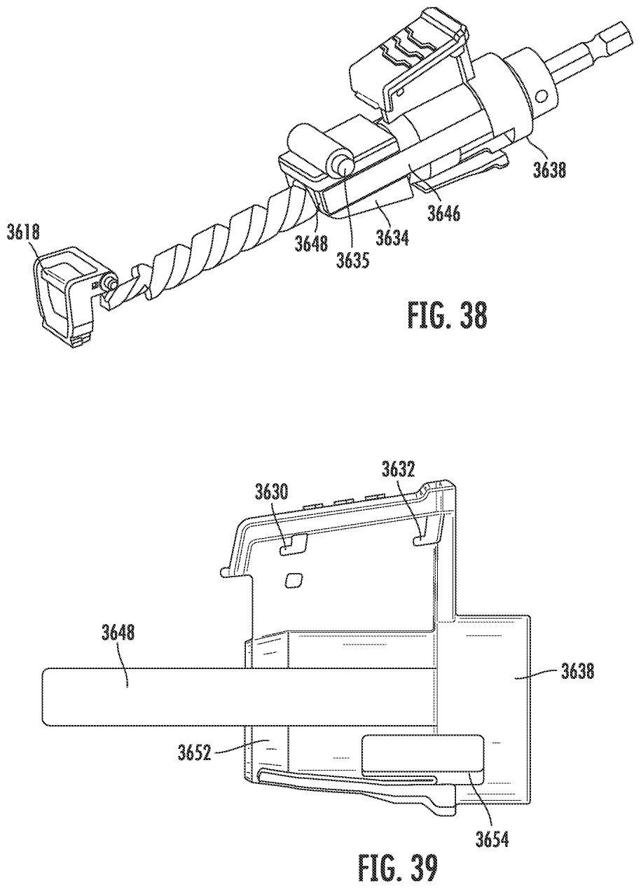

FIGS. 36 to 41 illustrate embodiments of a pocket hole jig. FIGS. 36 to 40 illustrate a single hole pocket jig 3600 and FIG. 41 illustrates a multi-hole pocket jig 4100. The pocket hole jigs 3600 and 4100 depicted in FIGS. 36 to 41 may include any one or more similar features or attributes as compared to the pocket hole jigs 100 or 700 described with respect to FIGS. 1 to 8C.

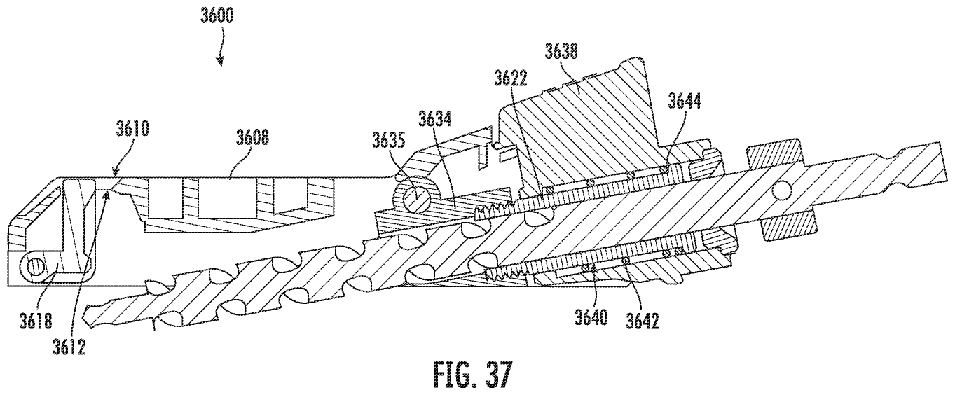

Referring to FIGS. 36 to 39, the pocket hole jig 3600 includes a housing 3602 having a first sidewall 3604 and a second sidewall 3606 spaced apart from the first sidewall 3604. A top 3608 can include an upper portion 3610 and a lower portion 3612. The housing 3602 includes a proximal end 3614 and a distal end 3616. A pivoting nose fence 3618 can be disposed at the distal end 3616 of the housing 3602 and can pivot about a pivot axis 3620 between a stored position (FIG. 37) and a deployed position (FIG. 36).

The pocket hole jig 3600 further includes a drill bit guide 3622 disposed at the proximal end of the housing 3602. The drill bit guide 3622 can be coupled to a bushing 3638. The bushing 3638 can interface with a plurality of lock structures of the housing 3602, such as e.g., a first locking notch 3624, a second locking notch 3626, and a third locking notch 3628, disposed at the top 3608 of the housing 3602. The bushing 3638 can include a second locking structure, such as a plurality of locking tabs, e.g., a first locking tab 3630 and a second locking tab 3632 (FIG. 39), that selectively interface with the locking notches to lock the drill bit guide 3622 at a fixed relative position with respect to the housing 3602. In certain instances, use of a single locking tab can incur canting or relative movement of the drill bit guide 3622 with respect to the housing 2602. Use of a plurality of locking tabs can stabilize the drill bit guide 3622 relative to the housing 3602 during use of the pocket hole jig 3600 by forming a plurality of attachment points therebetween. As such, canting and relative movement between the drill bit guide 3622 and the housing 3602 is mitigated or even eliminated.

The drill bit guide 3622 can be coupled to the housing 3602 through an intermediary component 3634 that is coupled to the housing 3602 by an axle 3635 at a pivot point 3636. The intermediary component 3634 can pivot relative to the housing 3602 at the pivot point 3636. and the drill bit guide 3622 can provide a guide surface 3640 for the bushing 3638 to move along. By translating the bushing 3638 away from the pivot point 3636 along the guide surface 3640, the locking tabs of the bushing 3638 can unlock from the locking notches of the housing 3602. Conversely, by translating the bushing 3638 towards the pivot point 3622 along the guide surface 3640, the locking tabs of the bushing 3638 can lock relative to the locking notches of the housing 3602. The bushing 3638 can be spring-loaded to the locked position by a spring 3642 disposed between the bushing 3638 and a spring seat 3644 of the drill bit guide 3622.

The bushing 3638 can include a rail 3646 that aligns with a channel 3648 of the intermediary component 3634. As the bushing 3638 is moved along the guide surface 3640, the rail 3646 can translate (slide) within the channel 3648 to prevent canting and relative instability between the drill bit guide 3622 and the housing 3602. The rail 3646 and channel 3648 can interface with one another and prevent relative movement between the drill bit guide 3622 and the housing 3602 when the bushing 3638 is moved to a proximal-most locked position and only one of the locking tabs 3630 is coupled to one of the notches 3628.

Similar to pocket hole jigs 100 and 700, the pocket hole jig 3600 allows an operator to change a relative angle and position of the pocket hole based on a relative position of the bushing 3638. The bushing 3638 may be movable between a plurality of different positions with respect to the housing 3602, each of the positions providing a different pocket hole angle and position. For instance, when the bushing 3638 is interfaced with the first and third notches 3634 and 3638 as depicted in FIG. 36, the pocket hole jig 3600 is in the shallowest setting. By moving the bushing 3638 away from the pivot point 3636, the operator can increase the angle of the pocket hole relative to an underlying workpiece. To move the bushing 3638, the operator first disengages the tabs (e.g., tabs 3630 and 3632) from the notches 2624, 2626, and 3628 by moving the bushing 3638 away from the pivot point 3636. The bushing 3638 is then rotated about the pivot point 3636 until the tabs are clear of the notches. The bushing 3638 can then be moved either towards or away from the pivot point 3636 until at least one of the tabs (e.g., tabs 3630 and 3632) is aligned with at least one of the notches 2624, 2626, and 3628. The bushing 3638 is then pivoted about the pivot point 3636 until the tab(s) interface with corresponding notch(es) 2624, 2626, and 3628 and the bushing 3638 is released. The spring 3642 automatically biases the tab(s) into the notch(es) 2624, 2626, and 3628 to prevent the bushing 3638, and thus the drill bit guide 3622, from moving. In each position, a guide axis 3650 formed by the drill bit guide 3622 is different, resulting in a different angle of a resulting pocket hole drilled in the workpiece.

Referring to FIG. 39, the bushing 3638 includes a sidewall 3652. The sidewall 3652 can extend around the drill bit guide 3622 in the assembled state. The sidewall 3652 can include one or more chip ejection ports 3654. The chip ejection ports 3654 can extend through the sidewall 3652 and allow for discharge of dust and chips formed when the pocket holes are being drilled. In an embodiment, the chip ejection ports 3654 can be disposed at a lower end of the sidewall 3652 to permit dust and chips to fall out of the sidewall 3652 and prevent internal buildup, particularly when the drill bit guide 3622 is covered by the bushing 3638 as may occur in certain relative positions.

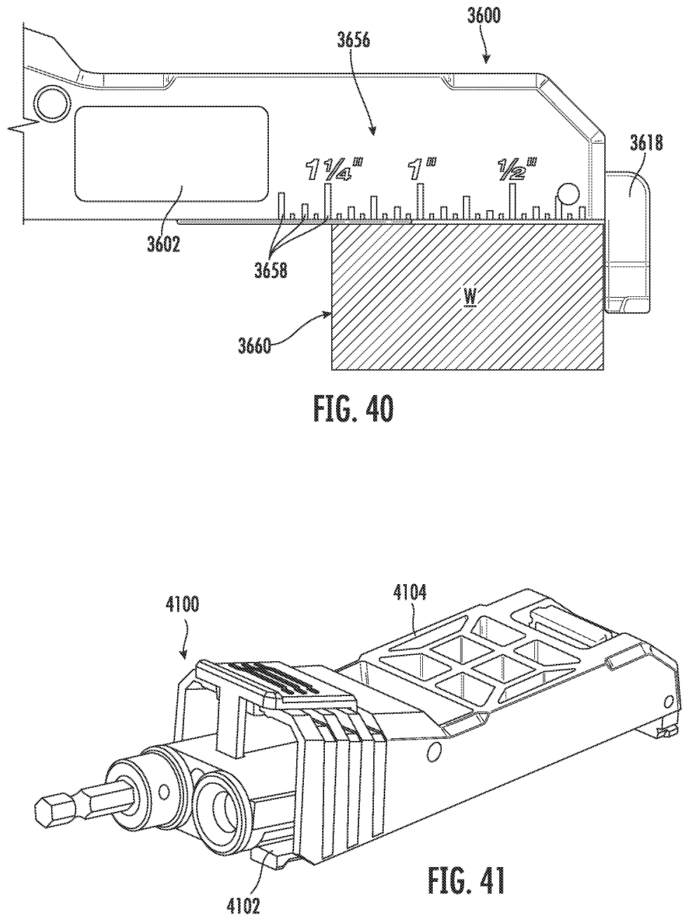

The pocket hole jig 3600 can include features that allow an operator to quickly reference information to determine which setting the pocket hole jig 3600 should be set at for a particular workpiece. FIG. 40 illustrates an enlarged view of a portion of the pocket hole jig 3600 including an indicator 3656 that indicates a correct setting for the pocket hole jig 3600 in view of the size of a workpiece W. The indicator 3656 can include indicia 3658 with labels. The labels can provide information about the dimension of the workpiece W (e.g., ½″ thickness, 1″ thickness, 1¼ ″ thickness, etc.). To measure the workpiece W, the operator presses the workpiece W into the pivoting nose fence 3618 and determines which indicia 3658 is closest to a dimensional face 3660 of the workpiece W. Using this information, the operator adjusts the bushing 3638 (FIG. 36) to an appropriate material thickness setting by selecting an appropriate one or more of the notches 3624, 3626, and 3628. The operator may also use this information to select an appropriate length fastener.

FIG. 41 illustrates a multi-hole pocket jig 4100 in accordance with an embodiment. The multi-hole pocket jig 4100 can be substantially similar to the pocket hole jig 3600 depicts in FIGS. 36 to 40. For example, the multi-hole pocket jig 4100 can include a bushing 4102 that is repositionable relative to a housing 4104 to set an angle of a pocket hole. Unlike the pocket hole jig 3600 depicted in FIGS. 36 to 40, the bushing 4102 of the multi-pocket hole jig 4100 includes a plurality of interfaces for receiving drill bits. Additionally, the multi-pocket hole jig 4100 includes a different drill bit guide for each of the interfaces.

Further aspects of the invention are provided by one or more of the following embodiments:

Embodiment 1. A pocket hole jig comprising: a body; an actuator operatively coupled to the body; a clamp head movable relative to the body to selectively secure an object in a clamping region of the pocket hole jig; and a drill guide defining a guide axis for a drill bit, wherein the actuator is moveable between an open position and a closed position, wherein movement of the actuator from an open position to a closed position tightens the clamp head against the object and locks the clamp head in a tightened state against the object, and wherein movement of the actuator from an open position to a closed position pivots the drill guide and locks the drill guide with the guide axis at a specified alignment with respect to the clamping region.

Embodiment 2. The pocket hole jig of any one or more of the embodiments, wherein movement of the actuator comprises pivotable movement.

Embodiment 3. The pocket hole jig of any one or more of the embodiments, wherein the closed position for the actuator, as measured relative to the body, is substantially the same regardless of a size of the object in the clamping region.

Embodiment 4. The pocket hole jig of any one or more of the embodiments, wherein the actuator is coupled to the body through a spring-biased interface configured to take up any additional travel of the actuator to the closed position once the clamp head is in the tightened state against the object in the clamping region.

Embodiment 5. The pocket hole jig of any one or more of the embodiments, wherein movement of the actuator causes the drill guide to pivot until the clamp head is in a tightened state against the object in the clamping region after which point the drill guide does not further pivot upon additional movement of the actuator.

Embodiment 6. The pocket hole jig of any one or more of the embodiments, wherein the actuator is moveable to the closed position and lockable in the closed position using a single hand.

Embodiment 7. A pocket hole jig comprising: a body; an actuator operatively coupled to the body; a clamp head movable relative to the body to selectively secure an object in a clamping region of the pocket hole jig; and a drill guide defining a guide axis for a drill bit, wherein the actuator is moveable between an open position and a closed position, and wherein movement of the actuator from an open position to a closed position tightens the clamp head against the object and locks the clamp head in a tightened state against the object.

Embodiment 8. The pocket hole jig of any one or more of the embodiments, wherein the drill guide is pivotable relative to the body, and wherein movement of the actuator pivots the drill guide relative to the body.

Embodiment 9. The pocket hole jig of any one or more of the embodiments, further comprising a support arm which, in combination with the actuator, forms a squeezable interface for moving the actuator to the closed position.

Embodiment 10. The pocket hole jig of any one or more of the embodiments, wherein the closed position for the actuator, as measured relative to the support arm, is substantially the same regardless of a size of the object in the clamping region.

Embodiment 11. The pocket hole jig of any one or more of the embodiments, wherein the actuator is coupled to the body through a spring-biased interface configured to take up any additional travel of the actuator to the closed position once the clamp head is in the tightened state against the object in the clamping region.

Embodiment 12. The pocket hole jig of any one or more of the embodiments, wherein a first portion of the movement of the actuator from the open position to the closed position tightens the clamp head against the object, and wherein a second portion of the movement of the actuator locks the clamp head in the tightened state.

Embodiment 13. The pocket hole jig of any one or more of the embodiments, wherein movement of the actuator comprises pivotable movement.

Embodiment 14. A pocket hole jig comprising: a body; an actuator operatively coupled to the body; a clamp head movable relative to the body to selectively secure an object in a clamping region of the pocket hole jig; and a drill guide defining a guide axis for a drill bit, wherein the actuator is moveable between an open position and a closed position, and wherein movement of the actuator from an open position to a closed position pivots the drill guide and locks the drill guide with the guide axis at a specified alignment with respect to the clamping region.

Embodiment 15. The pocket hole jig of any one or more of the embodiments, wherein movement of the actuator from the open position to the closed position tightens the clamp head against the object and locks the clamp head in a tightened state against the object.

Embodiment 16. The pocket hole jig of any one or more of the embodiments, wherein the actuator is coupled to the body through a spring-biased interface configured to take up any additional travel of the actuator to the closed position once the clamp head is in a tightened state against the object in the clamping region.

Embodiment 17. The pocket hole jig of any one or more of the embodiments, wherein movement of the actuator causes the drill guide to pivot until the clamp head is in a tightened state against the object in the clamping region after which point the drill guide does not further pivot upon additional movement of the actuator.

Embodiment 18. The pocket hole jig of any one or more of the embodiments, further comprising an adjustment mechanism connecting the actuator, the clamp head, and the drill guide together, wherein motion of the adjustment mechanism is delimited by the body.

Embodiment 19. The pocket hole jig of any one or more of the embodiments, wherein the adjustment mechanism comprises: a first connector linking the actuator and the clamp head together; and a second connector linking the first connector and the drill guide together.

Embodiment 20. The pocket hole jig of any one or more of the embodiments, further comprising a dust extraction element coupled to the drill guide.

Embodiment 21. A pocket hole jig comprising: a housing that orients the pocket hole jig relative to a workpiece; and a drill bit guide rotatably coupled to the housing, wherein the housing comprises a plurality of locking notches, and wherein the drill bit guide is interfaceable with different ones of the plurality of locking notches to adjust a drill angle of the drill bit guide with respect to the workpiece.

Embodiment 22. The pocket hole jig of any one or more of the embodiments, wherein the drill bit guide is interfaced with the plurality of locking notches through a spring-loaded bushing.

Embodiment 23. The pocket hole jig of any one or more of the embodiments, wherein the spring-loaded bushing comprises an upper user interface and a low user interface, and wherein the drill bit guide passes between the upper and lower user interfaces.

Embodiment 24. The pocket hole jig of any one or more of the embodiments, further comprising a translating nose fence coupled to the housing and moveable between a stored position and a deployed position along an axis forming a relative angle with respect to a surface of the workpiece, the relative angle between 0° and 90°.

Embodiment 25. The pocket hole jig of any one or more of the embodiments, wherein adjusting the drill bit guide comprises: pulling on the drill bit guide until a locking tab associated with the drill bit guide is clear of a first of the plurality of notches; rotating the drill bit guide until the locking tab is aligned with a second of the plurality of notches; and releasing the drill bit guide so the locking tab slides into the second of the plurality of notches.

Embodiment 26. The pocket hole jig of any one or more of the embodiments, wherein pulling, rotating and releasing the drill bit guide is performed using a spring-loaded bushing coupled to the drill bit guide.

Embodiment 27. A pocket hole jig comprising: a body; an actuator moveably coupled to the body; a clamp head moveable between an open state and a closed state, wherein the clamp head selectively secures a workpiece in a clamping region of the pocket hole jig in the closed state; a spring biasing the clamp head to the open state; a drill guide defining a guide axis for a drill bit; and a linkage extending between the actuator and each of the clamp head and the drill guide to move the clamp head between the open and closed states in response to movement of the actuator.

Embodiment 28. The pocket hole jig of any one or more of the embodiments, wherein the clamp head moves towards the actuator when the clamp head moves to the closed state.

Embodiment 29. The pocket hole jig of any one or more of the embodiments, further comprising: a spring stop disposed at least partially within the body and defining a spring seat to support an end of the spring, wherein the spring is disposed between the spring seat and the clamp head, and wherein a portion of the linkage extends through the spring.

Embodiment 30. The pocket hole jig of any one or more of the embodiments, wherein the drill guide is coupled to the body through a carriage, and wherein the carriage is rotated relative to the body by the drill guide when the actuator is moved.

Embodiment 31. The pocket hole jig of any one or more of the embodiments, wherein the drill guide translates relative to the carriage when the actuator is moved.

Embodiment 32. The pocket hole jig of any one or more of the embodiments, wherein the carriage comprises an opening and a quick attachment interface, and wherein the pocket hole jig is configured to receive a dust port including a conduit in fluid communication with the opening when a complementary quick attachment interface of the dust port is coupled to the quick attachment interface of the carriage.

Embodiment 33. The pocket hole jig of any one or more of the embodiments, wherein the body, or a secondary structure coupled to the body, extends through both the carriage and the drill guide to form a guide, and wherein the guide causes the carriage and drill guide to move in a prescribed roto-translational movement as the linkage moves in response to movement of the actuator.

Embodiment 34. The pocket hole jig of any one or more of the embodiments, wherein the pocket hole jig further comprises an indicator to indicate a fastener size to use for a pocket hole to be drilled in the workpiece using the pocket hole jig, based on a relative position of the clamp head when the workpiece is secured within the clamping region.

Embodiment 35. The pocket hole jig of any one or more of the embodiments, wherein the linkage comprises: a first link coupled to the clamp head; and a second link rotatably and slidably coupled to the first link and rotatably coupled to the drill guide.

Embodiment 36. The pocket hole jig of any one or more of the embodiments, wherein the linkage further comprises: a third link rotatably coupled to the first link and rotatably coupled to the actuator, wherein the third link transmits rotational movement of the actuator to linear movement of the first link.

Embodiment 37. A pocket hole jig comprising: a body; an actuator moveably coupled to the body; a clamp head moveable between an open state and a closed state in response to movement of the actuator, wherein the clamp head selectively secures a workpiece in a clamping region of the pocket hole jig in the closed state; a drill guide defining a guide axis for a drill bit to drill a pocket hole in the workpiece secured in the clamping region; and a dust extractor including a dust port configured to be removably coupled to an area of the pocket hole jig in communication with the drill guide, wherein the dust port is reversible between a first orientation relative to the body and a second orientation relative to the body, the first and second orientations being opposite one another.

Embodiment 38. The pocket hole jig of any one or more of the embodiments, wherein the drill guide is coupled to the body through a carriage, wherein the carriage defines an opening in communication with the drill guide, wherein the carriage comprises a quick attachment interface, and wherein the dust port comprises a complementary quick attachment interface configured to slidably engage with the quick attachment interface of the carriage.

Embodiment 39. The pocket hole jig of any one or more of the embodiments, wherein the dust port moves relative to the body in response to movement of the actuator.

Embodiment 40. The pocket hole jig of any one or more of the embodiments, wherein the pocket hole jig further comprises a linkage extending between the actuator and each of the clamp head and the drill guide to move the clamp head between the open and closed states in response to movement of the actuator, wherein at least a portion of the linkage is guided by one or more slots in the body, and wherein at least one of the one or more slots extends entirely through a sidewall of the body.

Embodiment 41. The pocket hole jig of any one or more of the embodiments, wherein the body defines an ingress opening in communication with the clamping region and an egress opening in communication with the ingress opening, and wherein dust from a drilling operation in the clamping region enters the body through the ingress opening and exits the body through the egress opening.

Embodiment 42. The pocket hole jig of any one or more of the embodiments, wherein the ingress opening is disposed at a first vertical elevation below the clamping region, and wherein the dust port is disposed at a second vertical elevation above the clamping region.

Embodiment 43. A pocket hole jig comprising: a housing including a plurality of first lock structures; an axle coupled to the housing; a drill bit guide coupled to the axle, the drill bit guide defining a guide axis; and a spring-loaded bushing coupled to the drill bit guide, the spring-loaded bushing including at least one second lock structure, wherein the spring-loaded bushing is translatable along the drill bit guide between an engaged position where the at least one second lock structure is engaged with one of the plurality of first lock structures to maintain the guide axis at a fixed angle relative to a workpiece and a disengaged position where the spring-loaded bushing is translatable along the drill bit guide and the drill bit guide is rotatable about the axle.

Embodiment 44. The pocket hole jig of any one or more of the embodiments, wherein the spring-loaded bushing is reconfigurable between a plurality of engaged positions, wherein the guide axis is different for each of the plurality of engaged positions, and wherein a position of the spring-loaded bushing relative to the drill bit guide is different for each of the plurality of engaged positions.

Embodiment 45. The pocket hole jig of any one or more of the embodiments, wherein the at least one second lock structure comprises a plurality of tabs, and the plurality of first lock structures comprises a plurality of recesses.

Embodiment 46. The pocket hole jig of any one or more of the embodiments, wherein the spring-loaded bushing includes a sidewall extending around at least a portion of the drill bit guide, and wherein the sidewall includes one or more chip ejection port.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A pocket hole jig comprising:
a body;
an actuator moveably coupled to the body;
a clamp head moveable between an open state and a closed state, wherein the clamp head selectively secures a workpiece in a clamping region of the pocket hole jig in the closed state;
a spring biasing the clamp head to the open state;
a drill guide defining a guide axis for a drill bit; and
a linkage extending between the actuator and each of the clamp head and the drill guide to move the clamp head between the open and closed states in response to movement of the actuator.

2. The pocket hole jig of claim 1, wherein the clamp head moves towards the actuator when the clamp head moves to the closed state.

3. The pocket hole jig of claim 1, further comprising:
a spring stop disposed at least partially within the body and defining a spring seat to support an end of the spring,
wherein the spring is disposed between the spring seat and the clamp head, and
wherein a portion of the linkage extends through the spring.

4. The pocket hole jig of claim 1, wherein the drill guide is coupled to the body through a carriage, and wherein the carriage is rotated relative to the body by the drill guide when the actuator is moved.

5. The pocket hole jig of claim 4, wherein the drill guide translates relative to the carriage when the actuator is moved.

6. The pocket hole jig of claim 4, wherein the carriage comprises an opening and a quick attachment interface, and wherein the pocket hole jig is configured to receive a dust port including a conduit in fluid communication with the opening when a complementary quick attachment interface of the dust port is coupled to the quick attachment interface of the carriage.

7. The pocket hole jig of claim 4, wherein the body, or a secondary structure coupled to the body, extends through both the carriage and the drill guide to form a guide, and wherein the guide causes the carriage and drill guide to move in a prescribed roto-translational movement as the linkage moves in response to movement of the actuator.

8. The pocket hole jig of claim 1, wherein the pocket hole jig further comprises an indicator to indicate a fastener size to use for a pocket hole to be drilled in the workpiece using the pocket hole jig, based on a relative position of the clamp head when the workpiece is secured within the clamping region.

9. The pocket hole jig of claim 1, wherein the linkage comprises:
a first link coupled to the clamp head; and
a second link rotatably and slidably coupled to the first link and rotatably coupled to the drill guide.

10. The pocket hole jig of claim 9, wherein the linkage further comprises:
a third link rotatably coupled to the first link and rotatably coupled to the actuator,
wherein the third link transmits rotational movement of the actuator to linear movement of the first link.

11. A pocket hole jig comprising:
a body;
an actuator moveably coupled to the body;
a clamp head moveable between an open state and a closed state in response to movement of the actuator, wherein the clamp head selectively secures a workpiece in a clamping region of the pocket hole jig in the closed state;
a drill guide defining a guide axis for a drill bit to drill a pocket hole in the workpiece secured in the clamping region; and
a dust extractor including a dust port configured to be removably coupled to an area of the pocket hole jig in communication with the drill guide, wherein the dust port is reversible between a first orientation relative to the body and a second orientation relative to the body, the first and second orientations being opposite one another.

12. The pocket hole jig of claim 11, wherein the drill guide is coupled to the body through a carriage, wherein the carriage defines an opening in communication with the drill guide, wherein the carriage comprises a quick attachment interface, and wherein the dust port comprises a complementary quick attachment interface configured to slidably engage with the quick attachment interface of the carriage.

13. The pocket hole jig of claim 11, wherein the dust port moves relative to the body in response to movement of the actuator.

14. The pocket hole jig of claim 11, wherein the pocket hole jig further comprises a linkage extending between the actuator and each of the clamp head and the drill guide to move the clamp head between the open and closed states in response to movement of the actuator, wherein at least a portion of the linkage is guided by one or more slots in the body, and wherein at least one of the one or more slots extends entirely through a sidewall of the body.

15. The pocket hole jig of claim 11, wherein the body defines an ingress opening in communication with the clamping region and an egress opening in communication with the ingress opening, and wherein dust from a drilling operation in the clamping region enters the body through the ingress opening and exits the body through the egress opening.

16. The pocket hole jig of claim 15, wherein the ingress opening is disposed at a first vertical elevation below the clamping region, and wherein the dust port is disposed at a second vertical elevation above the clamping region.

17. A pocket hole jig comprising:
a housing including a plurality of first lock structures;
an axle coupled to the housing;
a drill bit guide coupled to the axle, the drill bit guide defining a guide axis; and
a spring-loaded bushing coupled to the drill bit guide, the spring-loaded bushing including at least one second lock structure,
wherein the spring-loaded bushing is translatable along the drill bit guide between an engaged position where the at least one second lock structure is engaged with one of the plurality of first lock structures to maintain the guide axis at a fixed angle relative to a workpiece and a disengaged position where the spring-loaded bushing is translatable along the drill bit guide and the drill bit guide is rotatable about the axle.

18. The pocket hole jig of claim 17, wherein the spring-loaded bushing is reconfigurable between a plurality of engaged positions, wherein the guide axis is different for each of the plurality of engaged positions, and wherein a position of the spring-loaded bushing relative to the drill bit guide is different for each of the plurality of engaged positions.

19. The pocket hole jig of claim 17, wherein the at least one second lock structure comprises a plurality of tabs, and the plurality of first lock structures comprises a plurality of recesses.

20. The pocket hole jig of claim 17, wherein the spring-loaded bushing includes a sidewall extending around at least a portion of the drill bit guide, and wherein the sidewall includes one or more chip ejection port.
